(19) United States
(12) Patent Application Publication
(10) Pub. No.: US 2025/0217080 A1
(43) Pub. Date: Jul. 3, 2025

(54) DISTRIBUTED STORAGE SYSTEMS AND METHODS THEREOF, DEVICE AND STORAGE MEDIUM

(71) Applicant: ZHEJIANG DAHUA TECHNOLOGY CO., LTD., Hangzhou (CN)

(72) Inventors: Tao XU, Hangzhou (CN); Xiumei YING, Hangzhou (CN); Xin LUO, Hangzhou (CN); Wenlong JIANG, Hangzhou (CN); Mingwei ZHOU, Hangzhou (CN)

(73) Assignee: ZHEJIANG DAHUA TECHNOLOGY CO., LTD., Hangzhou (CN)

(21) Appl. No.: 19/086,188

(22) Filed: Mar. 21, 2025

Related U.S. Application Data
(63) Continuation of application No. PCT/CN2023/118948, filed on Sep. 15, 2023.

(30) Foreign Application Priority Data
Sep. 21, 2022 (CN) 202211154101.5

(51) Int. Cl. G06F 3/06

(52) U.S. Cl. CPC G06F 3/0659; G06F 3/0604; G06F 3/067

(57) ABSTRACT

The embodiments of the present disclosure provide a distributed storage system and a method thereof. The system includes a client, a management node, and at least one storage node, wherein: the management node is configured to determine at least one first storage node from the at least one storage node in response to a data storage request of storing target data sent by the client; and each of the at least one storage node is configured to write the target data sent by the client to a target storage area of a storage device corresponding to the storage node in response to a data write request when the storage node is determined to be the first storage node.

### CROSS-REFERENCE TO RELATED APPLICATIONS

This application is a continuation of International Application No. PCT/CN2023/118948, filed on Sep. 15, 2023, which claims priority to Chinese Application No. 202211154101.5, filed on Sep. 21, 2022, the entire contents of which are incorporated herein by reference.

### TECHNICAL FIELD

The present disclosure relates to the field of distributed processing technology and, in particular, to distributed storage systems and methods thereof.

### BACKGROUND

Distributed storage refers to a process that data is decentralized and stored into multiple storage servers, and clusters of storage nodes disperse client requests, realizing dynamic horizontal scalability. A Shingled Magnetic Recording (SMR) disk is a leading next-generation disk technology, where adjacent tracks are partially overlapped in sequence, which increases storage density per unit of storage medium, and reduces storage cost at a lower cost. Therefore, it is desirable to provide a scheme that efficiently uses SMR disk for distributed storage.

### SUMMARY

According to one or more embodiments of the present disclosure, a distributed storage system is provided. The system includes a client, a management node, and at least one storage node. The management node is configured to determine at least one first storage node from the at least one storage node in response to a data storage request of storing target data sent by the client. Each of the at least one storage node is configured to write the target data sent by the client to a target storage area of a storage device corresponding to the storage node in response to a data write request when the storage node is determined to be the first storage node.

According to one or more embodiments of the present disclosure, a distributed storage method implemented on a distributed storage system is provided, the method is executed by the at least one storage node. The method includes: determining a storage device configured to write data in response to the data write request of storing the target data sent by the client; in response to determining that the storage device is a shingled magnetic recording disk, selecting at least one available storage area in the shingled magnetic recording disk as a target storage area; and writing the target data sent by the client to the target storage area.

According to one or more embodiments of the present disclosure, a distributed storage method implemented to a distributed storage system, the method is performed by the client. The method includes: sending the data storage request to the management node to cause the management node to determine the at least one first storage node from the at least one storage node based on the data storage request; and initiating the data write request to the at least one first storage node to cause the at least one first storage node to determine the at least one target storage area from the storage areas of respective storage devices, wherein the target storage area is configured to write data transmitted by the client.

According to one or more embodiments of the present disclosure, a distributed storage method implemented to the distributed storage system is provided, the method is performed by the management node. The method includes: determining the at least one first storage node from the at least one storage node in response to the data storage request; and sending the at least one first storage node and the states of data blocks of an object to the target storage node, so that the client sending the data write request to the at least one first storage node.

According to one or more embodiments of the present disclosure, an electronic device is provided, the electronic device includes a processor, wherein the processor is configured to execute instructions to implement the distributed storage method mentioned above.

According to one or more embodiments of the present disclosure, a non-transitory computer-readable storage medium storing instructions/program data is provided, the computer-readable storage medium stores instructions/program data, wherein the instructions or the program data are configured to be executed to implement the distributed storage method mentioned above.

### BRIEF DESCRIPTION OF THE DRAWINGS

The present disclosure will be further described in the form of exemplary embodiments, which will be described in detail by the accompanying drawings. These embodiments are not limiting, in these embodiments, the same number denotes the same structure, wherein:

FIG. 1 is a schematic diagram illustrating an application scenario of a distributed storage system according to some embodiments of the present disclosure;

FIG. 2 is a schematic diagram illustrating a structure of a distributed storage system according to some embodiments of the present disclosure;

FIG. 3 is a schematic diagram illustrating information stored by a management node according to some embodiments of the present disclosure;

FIG. 4 is a flowchart illustrating an exemplary distributed storage method according to some embodiments of the present disclosure;

FIG. 5 is a schematic diagram illustrating information stored by a storage node according to some embodiments of the present disclosure;

FIG. 6 is a flowchart illustrating an exemplary distributed storage method performed by a storage node according to some embodiments of the present disclosure;

FIG. 7 is a flowchart illustrating an exemplary distributed storage method performed by a client according to some embodiments of the present disclosure;

FIG. 8 is a flowchart illustrating an exemplary distributed storage method executed by a management node according to some embodiments of the present disclosure;

FIG. 9 is a flowchart illustrating an exemplary data recovery executed by a management node according to some embodiments of the present disclosure;

FIG. 10 is a flowchart illustrating a list of active storage areas according to some embodiments of the present disclosure.

### DETAILED DESCRIPTION

To more clearly illustrate the technical solutions related to the embodiments of the present disclosure, a brief introduction of the drawings referred to the description of the embodiments is provided below. Obviously, the accompanying drawing in the following description is merely some examples or embodiments of the present disclosure, for those skilled in the art, the present disclosure may further be applied in other similar situations according to the drawings without any creative effort. Unless obviously obtained from the context or the context illustrates otherwise, the same numeral in the drawings refers to the same structure or operation.

It will be understood that the term “system,” “device,” “unit,” and/or “module” used herein are one method to distinguish different components, elements, parts, sections, or assemblies of different levels in ascending order. However, if other words may achieve the same purpose, the words may be replaced by other expressions.

As used in the disclosure and the appended claims, the singular forms “a,” “an,” and “the” include plural referents unless the descriptions clearly dictate otherwise. Generally speaking, the terms “comprise” and “include” only imply that the clearly determined steps and elements are included, and these steps and elements may not constitute an exclusive list, and the method or device may further include other steps or elements.

Flowcharts are used throughout the present disclosure to illustrate the operations performed by the system according to embodiments of the present disclosure. It should be understood that the preceding or following operations are not necessarily performed in precise order. Instead, the individual steps may be processed in reverse order or simultaneously. It is also possible to add other operations to these processes or to remove a step or steps of operations from these processes.

A Shingled Magnetic Recording (SMR) disk divides a magnetic track into several Bands, i.e., continuously writable disks composed of consecutive tracks, each band becomes a basic unit written according to sequence. The Band is the physical concept of the SMR disk, and a logical concept corresponding to the SMR disk is called a Zone, and a size of Zone is typically 256 MB. Data within the Zone may support random reads. However, the data within the Zone may only be written sequentially from beginning to end, i.e., the data is written backward according to a location of a write pointer, but not support random writing or in-place writing, which will result in overwriting of data on overlapping tracks.

In some embodiments of distributed storage using the SMR disk, an distributed object storage system may be designed based on a Zone Group (i.e., ZG), associating a set of initialized new Zones through ZGIDs, and concurrently and batch-writing segmented data corresponding to corrective deletion code to the Zone group respectively, providing a capability of unified load, management based on ZG hierarchy, and achieving an ability to manage the support of corrective code technology by achieving a capability management of support for a native SMR disk Zone space policy management. However, this approach requires management and maintenance of all storage areas (i.e., Zones) of the SMR disk on all storage nodes by the management node, which causes a large management burden to the management node, thereby making a distributed storage efficiency of the management node relatively poor. In addition, this approach makes this distributed storage scheme incompatible with other types of disks (e.g., a CMR disk, etc.).

A distributed storage method and system thereof are provided in the embodiments of the present disclosure. In the distributed storage method and system thereof, the management node is configured to determine at least one first storage node from the at least one storage node in response to a data storage request of storing target data sent by a client, and each storage node in the at least one first storage node determines on its own whether to write the data sent by the client to its SMR disk, and allocates the data sent by the client to which storage area on its SMR disk. In this way, the management node does not need to manage and maintain all the storage areas of all the SMR disks, and the management node may disregard the disk types of the storage nodes and manage all the storage nodes uniformly through a conventional distributed file management method, which not only realizes that the disk types of the storage nodes are fully transparent and insensitive to the management node, greatly reduces a management burden of the management node, but also improves a distributed storage performance of the management node, and a distributed storage system including at least one management node and at least one storage node may be compatible with other types of disks such as Conventional Magnetic Recording (CMR) disk.

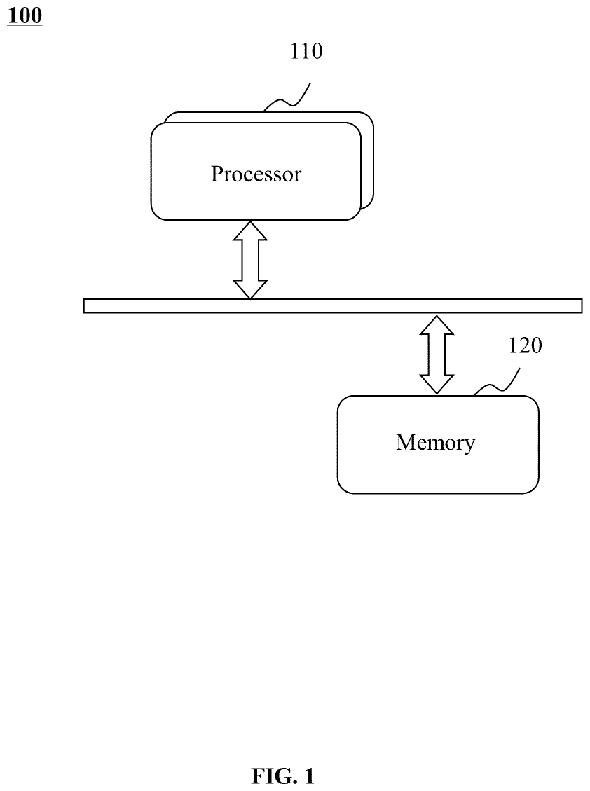

FIG. 1 is a schematic diagram illustrating an application scenario of a distributed storage system according to some embodiments of the present disclosure. In some embodiments, as shown in FIG. 1, an application scenario 100 may include a processor 110 and a memory 120.

The processor 110 may be configured to execute instructions to implement a distributed storage method (e.g., a process 400, a process 600, a process 700, a process 800, or a process 900) implemented to a distributed storage system and a method provided by any non-conflicting combination.

In some embodiments, the processor 110 may include a Central Processing Unit (CPU). In some embodiments, the processor 110 may be an integrated circuit chip with a processing capability of signal. In some embodiments, the processor 110 may include one or more of a general-purpose processor, a digital signal processor (DSP), an application-specific integrated circuit (ASIC), a field programmable gate array (FPGA) or other programmable logic device, a discrete gate or transistor logic device, a discrete hardware component, or any other conventional processor. The general-purpose processor may be a microprocessor.

In some embodiments, the processor 110 may be local or remote. For example, the processor 110 may access information and/or materials stored in the memory 120 through a network. In some embodiments, the processor 110 may be directly connected to the memory 120 to access the information and/or materials stored therein. In some embodiments, the processor 110 may be a single server or a server group. The server group may be centralized or distributed. In some embodiments, processor 110 may execute on a cloud platform. For example, the cloud platform may include one of a private cloud, a public cloud, a hybrid cloud, etc. or any combination thereof.

The memory 120 may be configured to store instructions and/or program data required for an operation of the processor 110, the method provided by any one of the embodiments and any non-conflicting combinations thereof of the present disclosure (e.g., the process 400, the process 600, the process 700, the process 800, or the process 900) is executed when the instructions/program data are executed. In some embodiments, the instructions/program data may be formed into a program file stored in the memory 120 in a form of a software product. For example, the instructions may be stored in the memory 120 as the program file to cause a computer device (e.g., a personal computer, a server, or a network device, etc.) or the processor 110 to perform all or some of the operations of various embodiments of the present disclosure (e.g., process 400, process 600, process 700, process 800, or process 900).

In some embodiments, the memory 120 may include one or more storage components, each of which may be a stand-alone device or may be a portion of other devices. In some embodiments, the memory 120 may include random access memory (RAM), read-only memory (ROM), mass storage, removable memory (e.g., a USB flash drive, a removable hard disk), volatile read/write memory, etc., or any combination thereof. Exemplarily, the mass storage may include a magnetic disk, an optical disk, a solid-state disk, and the like. In some embodiments, the memory 120 may include various medium that may store a program code such as a disk or CD-ROM, or a device such as a computer, a server, a cell phone, a tablet, and the like. In some embodiments, the memory 120 may be implemented on the cloud platform.

It should be noted that the above application scenario 100 is merely provided for the purpose of illustrating and is not intended to limit the scope of the present disclosure. For those skilled in the art, various amendments and variations of the process may be made under the teachings of the present disclosure. However, these variations and amendments do not depart from the scope of the present disclosure.

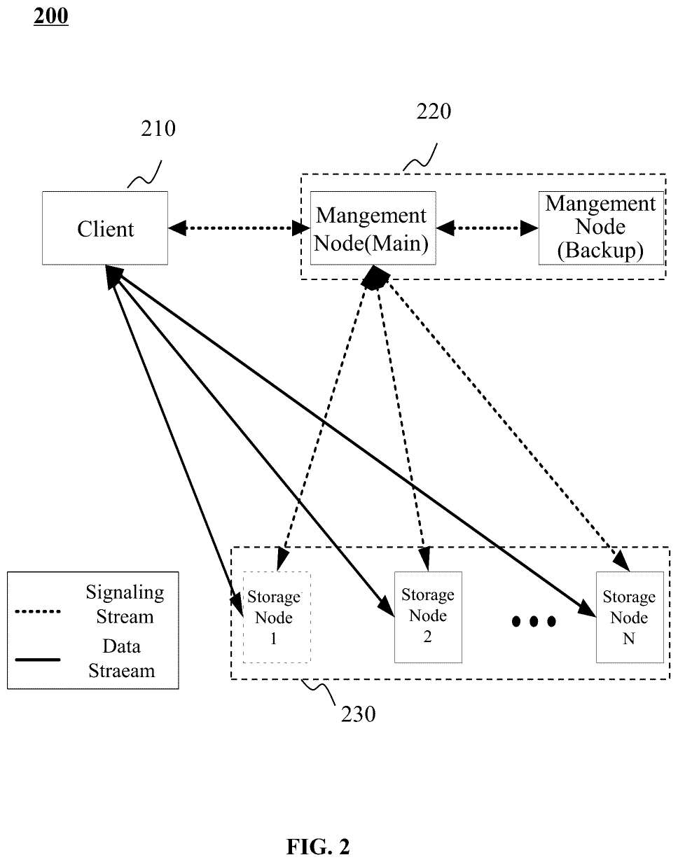

FIG. 2 is a schematic diagram illustrating a structure of a distributed storage system according to some embodiments of the present disclosure.

As shown in FIG. 2, in some embodiments, a distributed storage system 200 may include a client 210, a management node 220, and a storage node 230.

A client refers to a device or other entity used by a user associated with reading and writing data. In some embodiments, the client 210 may be a device having function of input and/or output, e.g., a mobile device, a tablet, a laptop, etc., or any combination thereof. In some embodiments, the client 210 may also include other smart terminals, such as a wearable smart terminal, etc. In some embodiments, the client 210 may include a device such as a mobile hard disk, a USB flash drive, and the like.

In some embodiments, the client 210 may encapsulate an interface to the outside world for an entire distributed storage system 200, i.e., the client is used as an entry point for user requests.

In some embodiments, the client 210 may be configured to send a data storage request to a management node to cause the management node to determine one or more storage nodes (e.g., a first storage node, a second storage node, a fourth storage node, and the like) configured to data storage based on the data storage request. For example, the user may send the data storage request to the management node 220 through the client 210 to store data into a storage device (a storage device may include a storage disk) (e.g., a target storage area of an SMR disk).

The data storage request refers to a request related to data storage (e.g., to disk) to be performed. For example, the data storage request may be a request related to storing a file/object such as a video, document, audio, image, etc. The data storage request may include related information of the data to be written, e.g., a size of data to be written, storage duration, type (e.g., text, audio, video, etc.), frequency of use, etc.

In some embodiments, the user may send the data storage request to the management node through a Software Development Kit (SDK) of client. Exemplarily, the user may invoke the SDK of the client when sending the data storage request, where the SDK interface first requests a creation of a bucket ID from the management node 220 of metadata, and then requests a file identifier (file ID). Further, the SDK may request the management node 220 again based on a file ID to perform a space request, so that the data storage request is sent to the management node 220 through the SDK client.

In some embodiments, the data to be written corresponding to the data storage request may be written to the storage device (e.g., a storage device) in one complete pass, or continuously written to the storage device in batches. Taking a video file as an example, when the client 210 sends the data storage request to the management node 220, the management node 220 may continuously obtain partial information (e.g., a first object, a second object, a third object, and so on) of a video file over time until all of video information (e.g., an entire written file) is obtained.

In some embodiments, the client 210 may send a data write to a determined storage node configured to store the data to be written (e.g., the at least one first storage node, at least one second storage node, or at least one fourth storage node) to cause the corresponding storage node to determine at least one target storage area from an available storage area of respective storage devices. The data write may include the data write request and/or the data to be written. The target storage area is configured to write the data transferred by the client (i.e., the data to be written).

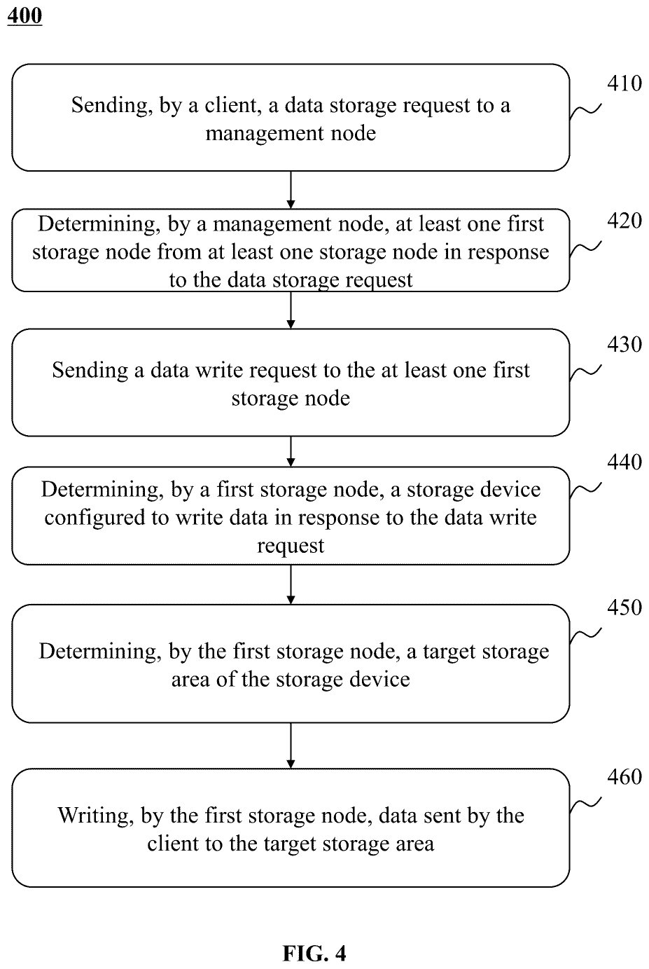

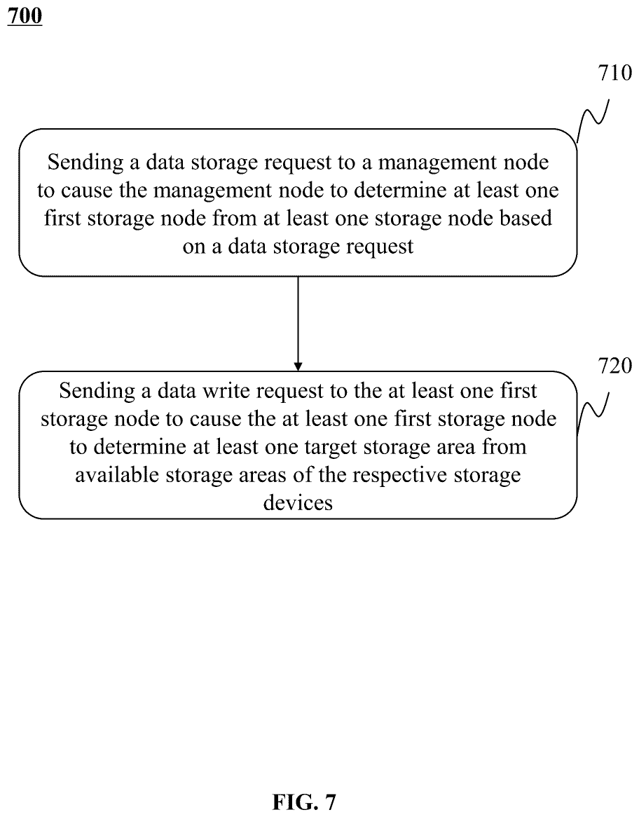

In some embodiments, the client 210 may determine a size of the first object written to a file based on a capacity of a target storage area selected by each of the at least one storage node, and extract a first object from the written file based on the size. Further, the client 210 may divide the first object into a target count of data blocks, and send the target count of data blocks to each of the target count of storage nodes (e.g., the first storage node), such that the storage node write the data blocks corresponding to the storage node to the target storage area. More descriptions regarding data write may be found in FIG. 4 and/or FIG. 7.

In some embodiments, the client 210 may send the data read request to the management node to perform a data read from a corresponding storage node determined by the management node (e.g., at least one third storage node).

The management node refers to a node used for a data management in the distributed storage system.

In some embodiments, the management node may be configured to respond to a metadata request of the distributed storage system 200, internally maintaining a metadata image of an entire system.

Metadata maintained by the management node may include states of files in the distributed storage system 200, i.e., the management node controls and manages a global file view of the distributed storage system 200. A plurality of objects may be stored in the management node, and each object may include a plurality of files, or each object may be a portion of a specific file. In the distributed storage system 200, all objects may be individually set with an object identification, so that the management node manages the objects based on the object identification.

In some embodiments, the global file view may include one or more of an object identification (object ID) of the object, an object state bit, an object offset in a file (file), a length and a location of a block contained in the object, and other information.

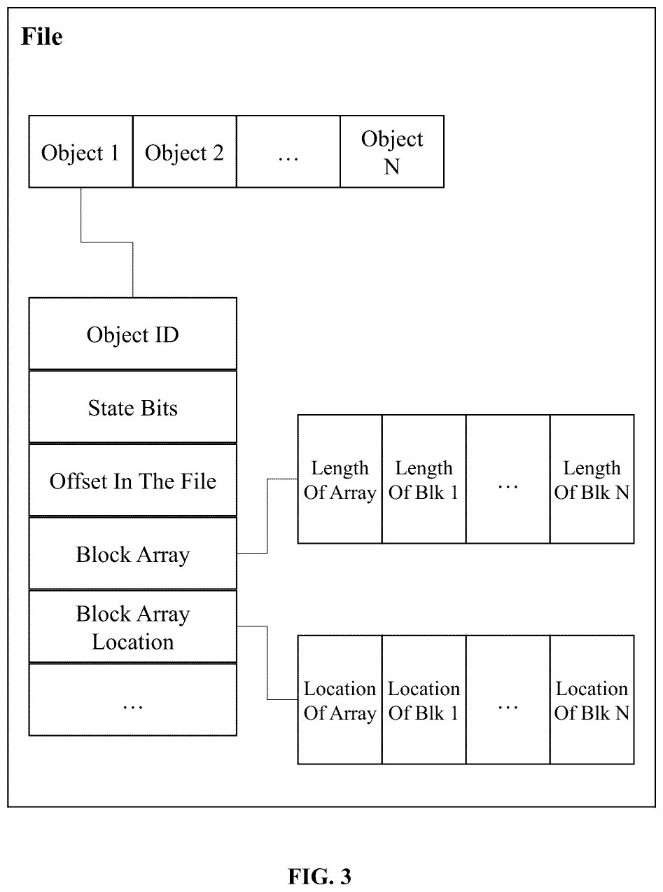

A schematic diagram of information stored in the management node is illustrated in FIG. 3. As shown in FIG. 3, the information stored in the management node 220 may include a file and a plurality of objects included in the file (e.g., an object 1, an object 2, . . . , and an object N). The management node 220 may control and manage the object ID, a state bits, an offset in the file, a length of a block included in the object (e.g., in N blocks included in the object 1, a length of Blk 1, . . . , and a length of Blk N), a location of the block included in the object (e.g., in N blocks included in the object 1, a length of Blk 1, . . . , and a length of Blk N), a location of the block included in the object (a location of Blk 1, . . . , and a location of Blk N) and other related information of each of the objects.

It may be understood that only related information of object 1 is illustrated in FIG. 3, which is merely an example and not a limitation of the present disclosure. Actually, each of the objects in FIG. 3 (e.g., object 2, . . . , and object N) has a corresponding object ID, a corresponding state bit, a corresponding offset in the file, a corresponding Block array, a corresponding Block array location, and other information.

In some embodiments, the management node 220 may determine the state of the object and/or the file to which the object belongs based on information reported by one or more storage nodes. For example, the management node 220 may obtain the states of all data blocks on the corresponding storage nodes from each of the storage node (e.g., a storage node 1, a storage node 2, . . . , and a storage node N, etc.) and determine the states of all data blocks of the object based on a mapping relationship between the data blocks and the object, thereby determining the state of the object and/or the file to which the object belongs based on the states of all data blocks of the object.

In some embodiments, the management node 220 may be configured to control a load balance of the storage node 230 in the distributed storage system 200. The management node (MDS) controls the load balance of the storage node (Data Node) may be understood as: the management node may determine a storage node (e.g., a first storage node, a second storage node, etc.) configured to store the data (also referred to as target data) sent by the client in response to the request for data storage sent by the client to achieve the load balance of the storage node.

In some embodiments, the management node 220 may determine the at least one storage node (e.g., the at least one first storage node, or at least one second storage node, etc.) from a plurality of storage nodes (e.g., the storage node 1, the storage node 2, . . . , the storage node N, etc.) in the distributed storage system 200) in response to a data storage request sent by the client 210, and the at least one storage node is configured to sore the data (e.g., the first object, the second object, etc.) that the client 210 requests to be written.

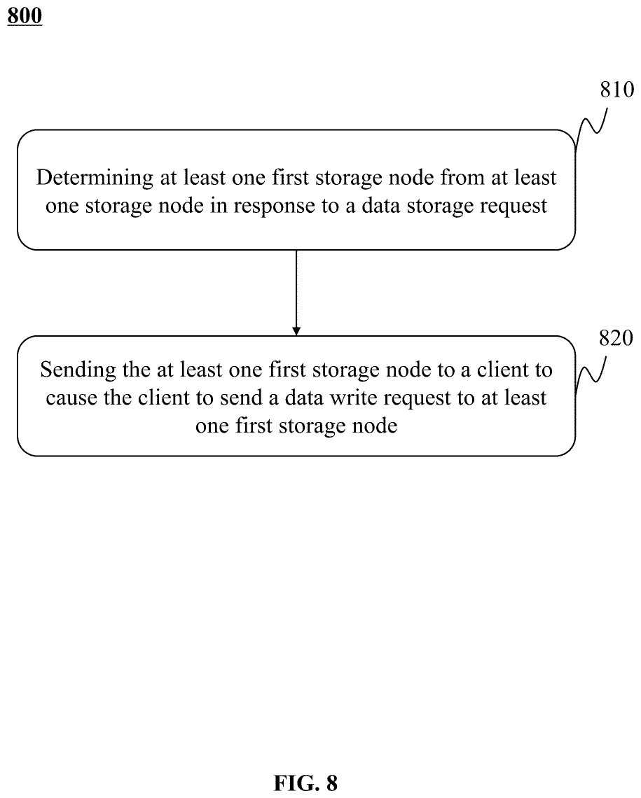

In some embodiments, the management node 220 may synthesize loads of all storage nodes throughout the distributed storage system 200 and determine the target count of storage nodes (e.g., a target count of first storage nodes or a target count of second storage nodes) in response to the data storage request based on a preset load balance strategy (e.g., a round robin, a weight selection, and a load selection), and send a determined storage node list back to the client (e.g., a SDK interface of the client), such that the client write the data to the determined storage nodes. More description of determining the storage nodes may be described in FIG. 4 and/or FIG. 8 and will not be repeated herein.

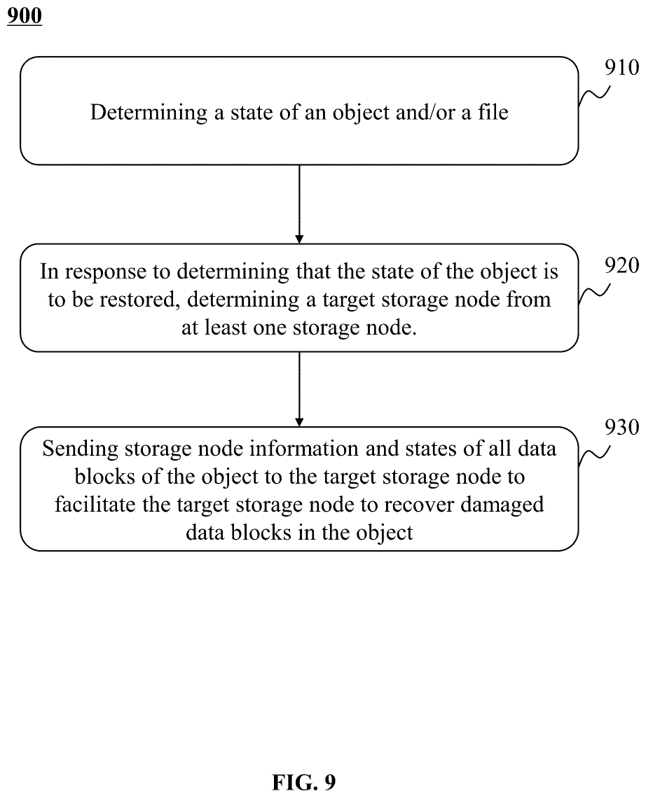

In some embodiments, the management node may be configured to control an operation of processes such as a file recovery. For example, the management node 220 may determine a target storage node from the at least one storage node in response to determining that the state of the object is to be recovered, and send storage node information and states of all the data blocks in the object to the target storage node, so that the target storage node recovers damaged data blocks in the object. More description regarding data recovery may be found in FIG. 9.

In some embodiments, the management node 220 may merely provide a function of metadata management, i.e., management of a corresponding signaling stream. At this point, an interaction of the data streams, i.e., a writing of real business data, is charged by the corresponding storage nodes (e.g., the first storage node, the second storage node, or the fourth storage node, etc.), as shown by a dashed arrows and a solid arrow in FIG. 2. For example, the management node 220 may determine at least one first storage node in response to a data storage request, and send a list of first storage nodes to the client 210, after which the client 210 sends the data write directly to each of the first storage nodes on the list of first storage nodes to write the data to the storage area. As another example, during file reading, after the client 210 obtains a list of third storage nodes from the management node 220 for data reading, the client 210 directly proceeds to perform the data reading on each of the third storage nodes in an obtained list.

In some embodiments, the distributed storage system 200 may include the one or more management nodes. For example, as shown in FIG. 2, the distributed storage system 200 may include a main management node, and one or more backup management nodes.

In some embodiments, the distributed storage system 200 may include the one or more storage nodes.

The storage node may be configured to provide functions such as a data stream write response, a nanotube disk, and/or periodic data block scanning uploading. For example, the data stream write response may be to determine a target storage device and/or a target storage area in response to a data write request sent by the client or the one or more management node. For example, when the storage node set up a registration, the storage node may perform a storage file information (e.g., block information) upload to the management node 220. The management node may update an internal block memory state metadata cache based on this information and update a real-time state of the file. As another example, the storage node may periodically report the internal storage file information (e.g., block information), and the one or more management nodes may perform a checksum to update the cache based on periodically reported information. As another example, when the writing of real-time business data sent by the client is completed, the storage node may report related information of the real-time written data (e.g., a mapping between the written data and the target storage area and the storage device it belongs to, current storage space information of the storage node, etc.) to the management node 220.

The periodic reporting and/or real-time reporting by the storage nodes may ensure a correctness of internal metadata cache of the one or more management nodes, and thereby ensuring the correctness and an accuracy of the load balance of the one or more management nodes.

In some embodiments, at least one type of hard disk may be added to the one or more storage node. In some embodiments, the one or more storage node may include a sequential storage-based disk node and other types of disk nodes. That is, the at least one type of hard disk added to the storage node may include a sequential storage-based disk and other types of disks.

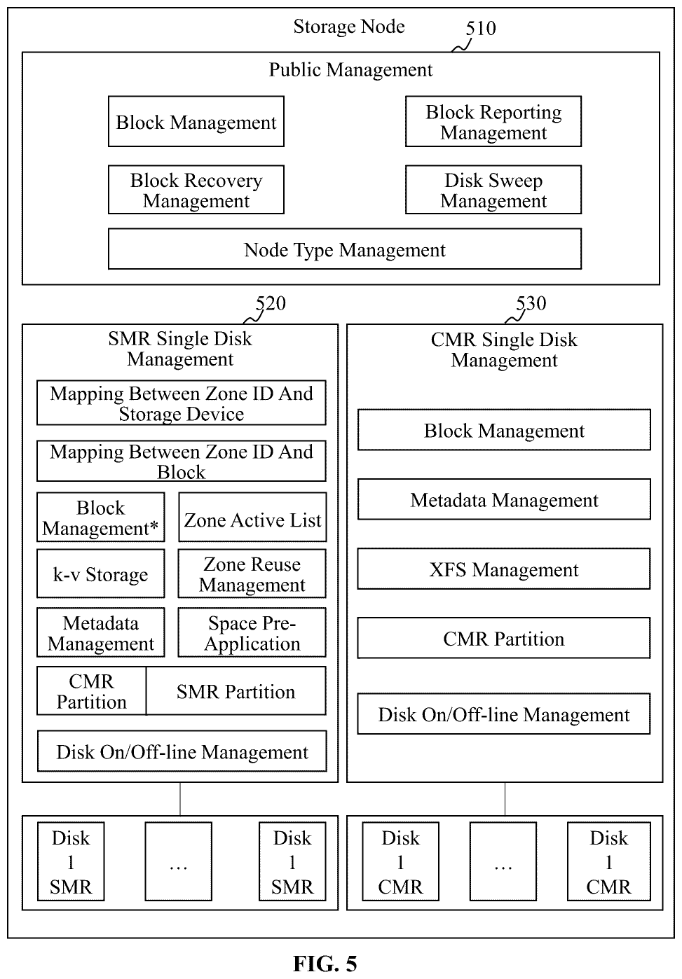

The sequential storage-based disk refers to a disk in which the data is written in a certain order, such as the SMR disk. Other types of disks are disks other than the sequential storage-based disk, such as Conventional Magnetic Recording (CMR) disks, LMR disks, and the like. Exemplarily, as shown in FIG. 5, the SMR disk and the CMR disk may be added to the storage node, and the SMR disk and CMR disks respectively have their corresponding single-disk management modules configured to manage corresponding disks.

In some embodiments, the storage node may include a public management module configured to manage one or more types of added disks (as shown in FIG. 5).

When merely one type of disk is added to the one or more storage node, in response to determining that the storage node is determined as a storage node to which the data write need to be performed (for example, to be determined as the first storage node), then a disk added to the storage node may be directly used as the storage device configured to write the data (also referred to as a target storage device).

In a case where the storage node has at least two types of disks added to the storage node, in response to determining that the storage node is determined as a storage node to which the data write is required (e.g., to be determined as the first storage node), the target storage device to be configured to write the data may be determined based on a storage policy (e.g., a load balance policy). For example, in response to determining that the disks added by the storage node include the SMR disk and the CMR disk, when the storage node is determined as the first storage node, the first storage node may select the target storage devices from the SMR disk and the CMR disk, and the target storage device is configured to write the data sent by the client.

In some embodiments, the storage node may be configured to provide a real data storage service, specifically configured to provide storage of file/object data block, i.e., the storage node is responsible for managing data written to this node.

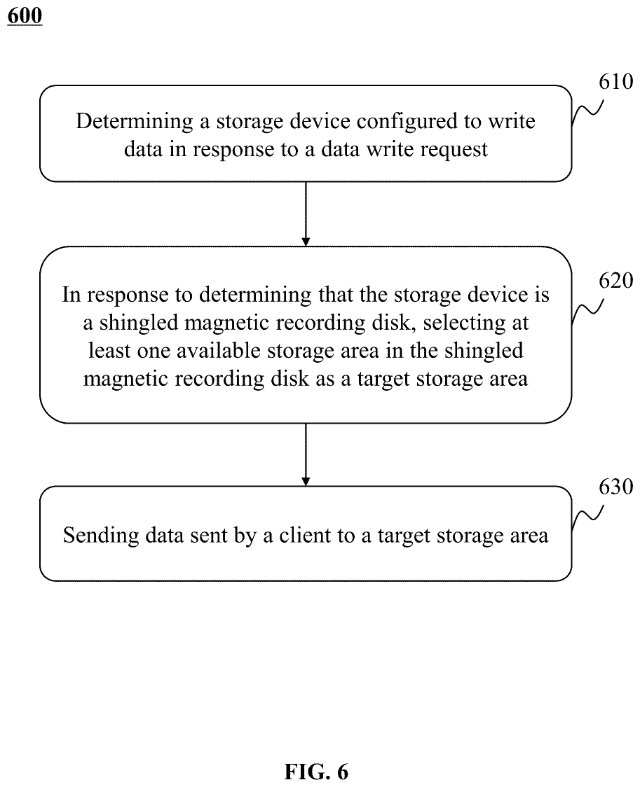

In some embodiments, when a storage node is determined as a storage node for data storage (e.g., the first storage node, or the second storage node, or the fourth storage node), the storage node may write the data sent by the client 210 to a target storage area of a storage device (e.g., a target storage device) corresponding to the storage node in response to the data write request. In some embodiments, the storage node may select at least one available storage area of the target storage device as the target storage area. More detailed descriptions may be found in FIG. 4 and/or FIG. 6.

In some embodiments, the storage node may set a storage area whose usage time being longer than a reuse cycle as a non-writable storage area. For example, the storage node may mark all space in the storage area whose usage time exceeds the reuse cycle as used. In some embodiments, when the usage time of the storage area exceeds the reuse cycle, the storage node may report to the management node that the storage space corresponding to the storage area has been written to full, so that the one or more storage node and the one or more management node are clearly and accurately aware of an amount of space available in the storage device (e.g., the SMR disk).

In some embodiments, a list of active storage areas of a storage device (e.g., the SMR disk) may be provided in the storage node. A list of active storage areas may include storage areas that are capable of responding to data write operations, such as the storage areas that have not been filled with data, i.e., storage areas that still have available space remaining.

Merely by way of example, as shown in FIG. 5, a list of active storage zones corresponding to the SMR disk may be designed in a single disk management module corresponding to the disk, and the storage zones in the list of active storage zones may be storage zones with remaining space greater than, or equal to, or less than an amount of data to be written (e.g., a size of the block of the first, second, or third object), and only the storage zones that are the storage Zone in the list of active storage Zones may be used in response to a current data write. A SMR single disk management module may cache and manage active storage Zone information.

Through a setting of the list of active storage areas, on the basis of, all Zone space may be avoided to be written to pieces through a setting of the list of active storage areas based on the storage device supporting certain concurrency, thereby allowing the storage node to concurrently and efficiently manage the storage areas (Zones) in the storage device (for example, the SMR disk), and improving an operation efficiency of the one or more storage node.

In some embodiments, when the storage zones whose usage time exceeds the reuse cycle exist in the active storage zone list, the one or more storage node may remove these storage zones from the active storage zone list. In some embodiments, the storage node may remove a target storage area from the list of active storage areas in response to determining that a used space of the target storage area is greater than or equal to a first ratio. In some embodiments, the storage node may delete data in an expired storage area in a storage device corresponding to the storage node. More detailed descriptions may be found in FIG. 4 and/or FIG. 6.

Through an active time management of the storage zone and the expired deletion of files within the storage zone, it is possible to maximize a space utilization rate of space, thereby enhancing the space utilization rate of the storage device (e.g., SMR disks) and the distributed storage system.

After experimental testing, combining the one or more storage node to achieve a space management of the storage Zone, the distributed storage system may be directly managed based on a native SMR disk, and the data write and data read may be achieved through the distributed storage methods provided in the embodiments of the present disclosure (e.g., the process 400, the process 600-process 900). Additionally, an unawareness of disk type difference of management node may be realized, significantly simplifying an architectural design of a distributed file system.

It should be noted that the above description of the distributed storage system 200 is merely provided for the purpose of illustrating and is not intended to limit the scope of the present disclosure. For those skilled in the art, various amendments and variations of the process may be made under the teachings of the present disclosure. However, these variations and amendments do not depart from the scope of the present disclosure.

FIG. 4 is a flowchart illustrating an exemplary distributed storage method implemented to a distributed storage system according to some embodiments of the present disclosure. In some embodiments, the process 400 may be executed by the processor 110 or the distributed storage system 200. The schematic diagram of an operation of the process 400 presented below is illustrative. In some embodiments, one or more additional operations not described and/or one or more operations not discussed may be utilized to complete the process. Further, an order of the operations of the process 400 illustrated in FIG. 4 and described below is not intended to be limited.

In 410, the client sends a data storage request to a management node. In some embodiments, 410 may be performed by the processor 110 or the distributed storage system 200 (e.g., the client 210).

When a client (e.g., client 210) has a data storage need, a data storage request may be sent to the management node (e.g., the management node 220) in the distributed storage system (e.g., the distributed storage system 200) to cause the management node to allocate the one or more storage nodes (e.g., the first storage node, the second storage node, the fourth storage node, etc.) to the client based on the data storage request, thereby writing the data to allocated storage nodes. More descriptions regarding the client sending the data storage request may be seen described in FIG. 7.

In 420, the management node determines at least one first storage node from at least one storage node in response to the data storage request. In some embodiments, 420 may be performed by the processor 110 or the distributed storage system 200 (e.g., the management node 220).

The first storage node may refer to a storage node configured to store data (e.g., a block of the object) requested to be written by the client. It is understood that “first” is used herein merely for differentiation. In some embodiments, the management node may determine at least a second storage node, or a fourth storage node, or the like, from the at least one storage node in response to the data storage request, and the present disclosure is not limited herein.

After obtaining the data storage request, the management node (e.g., management node 220) may select the at least one (e.g., a target count of) storage node (e.g., the first storage node, the second storage node, or the fourth storage node, etc.) from all the storage nodes based on the data storage of each of the storage nodes (e.g., the storage node 1, the storage node 2, . . . , and the storage node N), such that the client to write the data to the at least one storage node.

In some embodiments, a management node (e.g., management node 220) may determine the data storage of each of the storage nodes based on file storage information and/or storage space information reported by each of the storage nodes.

The file storage information may refer to related information of the file or the object stored in the one or more storage node, such as the type, the size, the storage location, the offset in the file, name, and the length and the location of the block corresponding to the object.

Reported storage space information are composed of node information of the one or more storage node. The node information refers to information relates to the storage node as a whole and does not contain information of sub-space or sub-nodes. For example, available space information reported by a storage node to a management node contains merely remaining available space of the one or more storage node, and does not contain information such as which storage area of the storage node the remaining available space corresponds to, and how much storage space remains in each of the storage areas.

In some embodiments, the management node may obtain information (e.g., the count of block of the object and/or the size of the block of the object) related to the written data in the data storage request, determine the at least one first storage node configured to store the written data based on the data storage of each of the storage nodes and the related information of the written data. In some embodiments, the management node may select a target count of first storage nodes configured to store the data requested to be written by the client from all the storage nodes. More descriptions may be found in the related description in FIG. 8.

Based on the file storage information and/or the storage space information reported by the storage node, the management node may determine a data storage situation of each of the storage nodes, which in turn may ensure a correctness of the metadata cache such as the data storage situation of each storage node recorded internally by the management node, which contributes to the correctness and the accuracy of the load balance of the management node, and facilitates the management node to more accurately determine the storage node that is configured to store the data sent by the client.

In some embodiments, the management node (e.g., management node 220) may feed a list of first storage nodes to a client (e.g., client 210), and the list of first storage nodes may include the at least one first storage node determined by the management node, so that the client writes data to the at least one first storage node.

In 430, a data write request to at least one first storage node is sent. In some embodiments, 430 may be performed by the processor 110 or the distributed storage system 200 (e.g., the client 210 or the management node 220).

In some embodiments, when determining the at least one first storage node, the management node (e.g., management node 220) may send the data write request to each of the first storage nodes of the at least one first storage node.

In some embodiments, after the management node selects the at least one first storage node configured to store the data and feeds the at least one first storage node configured to store the data back to the client, the client (e.g., the client 210) may send the data write request to each of the at least one first storage node.

By sending the data write request, the first storage node may be facilitated to determine whether to allocate the data sent by the client to its storage device (e.g., the SMR disk) and/or to allocate the data sent by the client to which storage area of the storage device, and write the data sent by the client to an allocated storage area (e.g., a target storage area) based on an allocation situation.

In 440, a first storage node determines a storage device configured to write data in response to the data write request. In some embodiments, 440 may be performed by the processor 110 or the distributed storage system 200 (e.g., the storage node 230).

In conjunction with the above description, at least one type of disk may be added to the storage node, and when determined as the storage node for the data storage, the storage node determines a storage device from the at least one type of disk configured to write the data in response to the data write request.

In some embodiments, when only one type of disk is added to a storage node determined as the first storage node, the storage node may determine a current disk as a target storage device.

In some embodiments, when two or more types of disks are added to the storage node determined as the first storage node, the storage node may determine the storage device configured to write the data based on a preset storage policy (e.g., prioritizing the write to a disk written based on sequential, or prioritizing the write to a disk having more available storage space, etc.). For example, in response to determining that the disk added to the storage node determined as the first storage node includes the SMR disk and the CMR disk, the first storage node may determine that the storage device configured to write the data is SMR disk or CMR disk. As another example, if the disks added on the storage node determined as the first storage node include a plurality of SMR disks and/or a plurality of CMR disks, the first storage node may determine which of the SMR disk or CMR disks is the storage device configured to write the data based on the preset storage policy.

In some embodiments, when two or more types of disks are added to the storage node determined as the first storage node, the first storage node may determine a corresponding type of disk as the target storage device based on disk information of the data write request. For example, the user may enter “use SMR disk for data write” in the data storage request or the data write request.

In some embodiments, when two or more types of disks are added to the storage node determined as the first storage node, the storage node may determine the target storage device based on one or more types of information such as the size of data block corresponding to the written data, a type of the object/file, a level of importance of the object/file, offset of object in the file, and a correlation of the data block with other data blocks.

In 450, the first storage node determines a target storage area of the storage device. In some embodiments, 450 may be performed by the processor 110 or the distributed storage system 200 (e.g., storage node 230).

The target storage area refers to the storage area to which the data write is to be performed.

In some embodiments, the first storage node may select at least one available storage area in the storage device (i.e., the target storage device) as the target storage area. The available storage area refers to a storage area in the storage device that is capable of writing the data sent by the client, e.g., a storage area having available space greater than or equal to the data sent by the client.

In some embodiments, the first storage node may select at least one of the available storage areas of the shingled magnetic recording disk as the target storage area in response to determining that the storage device is the shingled magnetic recording disk to write the data sent by the client to the target storage area. For example, after each of the first storage nodes of the at least one first storage node determines a storage device configured to write the data. In response to determining that the type of the storage device configured to write the data determined by the first storage node is an SMR disk, the first storage node may select one, two, or more of the available storage areas in the SMR disk as the target storage area, such that the data sent by the client is written to the target storage area.

In some embodiments, the first storage node may select at least one available storage area of the storage device as the target storage area based on the preset storage policy (e.g., a policy such as sequential picking). For example, the first storage node may select the at least one available storage area of the SMR disk as the target storage area based on a sequential picking policy.

In some embodiments, the target storage area of a determined storage device may include one or more. In some embodiments, the available space of the target storage area may be greater than or equal to a size of the data to be written (e.g., greater than or equal to a block size of the object to be written). In some embodiments, the available space of the target storage area may be less than the size of the data to be written. For example, the first storage node may determine two or more target storage areas of the storage device, where the available space of each of target storage areas is less than a block size of an object to be written, but a total available space of the two or more target storage areas is greater than or equal to the block size.

In some embodiments, the first storage node may select one or more storage areas capable of storing the data sent by the client from the list of active storage areas of the storage device, determine a selected storage area as the target storage area.

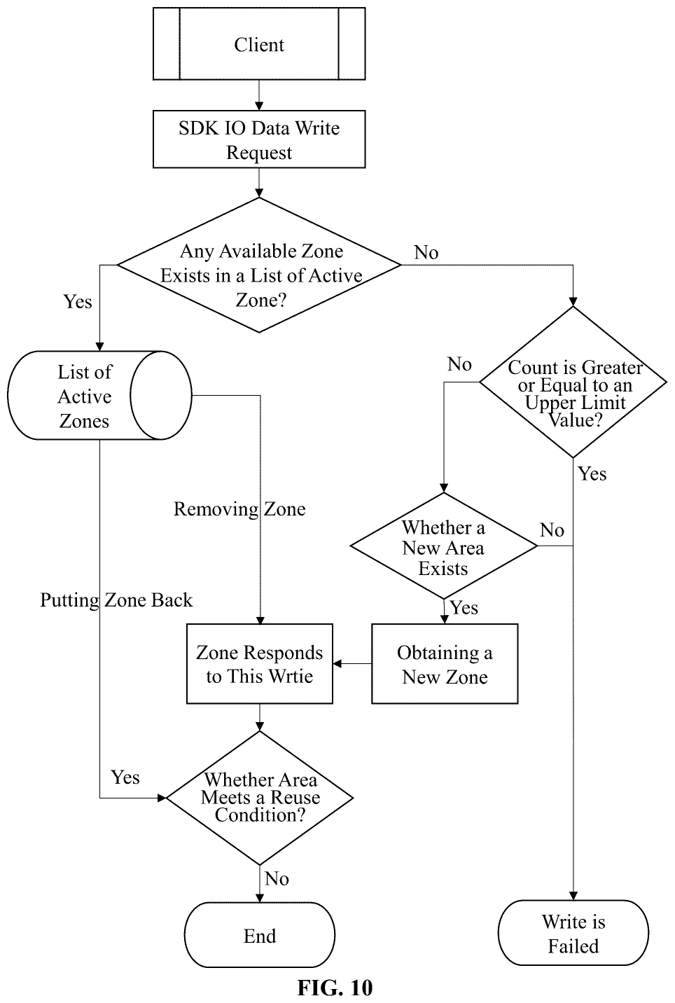

In some embodiments, the first storage node may first determine whether a storage area capable of storing the data sent by the client exists in the list of active storage areas of the storage device. In response to determining that the at least one storage area capable of storing the target data exists in the list of active storage areas, the at least one available storage area from the storage device (e.g., in the list of active storage areas) is selected as the target storage area, as shown in FIG. 10. The storage area capable of storing the data sent by the client may refer to a storage area where remaining available space may meet a requirement of an amount of data to be written, such as a storage area where the remaining available space is equal to or greater than a block size of the first object, the second object, or the third object. For example, the first storage node may compare the remaining available space of the storage area with the block size of the object to be written, which is located in the list of active storage areas. In response to determining that a storage area has the remaining available space equal to or greater than the block size exists in the list of active storage areas, the storage area capable of storing the data sent by the client in the list of active storage areas is determined to exist; otherwise, the storage area capable of storing the data sent by the client in the list of active storage areas is determined not to exist.

In some embodiments, when no storage area in the list of active storage areas having the remaining available space that may satisfy the requirement of the amount of data to be written, the first storage node may add a new storage area in the storage device to the list of active storage areas, and determine the new storage area as the target storage area. The new storage area may refer to a storage area of 0 used space.

In some embodiments, the first storage node may determine whether the size of the list of active storage areas is less than an upper limit value in response to determining that no storage area capable of storing the data sent by the client exists in the list of active storage areas. If the size of the list of active storage areas is less than an upper limit value, a new storage area in the storage device is added to the list of active storage areas.

The upper limit value may reflect an upper limit count of active storage areas in the list of active storage areas. In some embodiments, the upper limit value may be preset or determined in real time. For example, the upper limit value is determined in real time based on the size of the data to be written. In some embodiments, the upper limit value may be set based on information such as a hardware device situation of the storage node, the details of which are not limited herein.

By setting an upper limit value for the count of storage zones in the active storage zone list and determining whether to apply for the new storage zone based on the upper limit value, a degree of concurrency of the storage device (e.g., SMR disk) storage may be controlled to avoid generations of a plurality of Zone fragments, thereby improving an operation efficiency of the storage node.

In some embodiments, the storage node (e.g., the first storage node) may remove a storage area of which the remaining available space is lower than a lower limit value from the list of active storage areas, i.e., a storage area whose used space in the list of active storage areas is greater than or equal to a first ratio corresponding to the lower limit value is removed from the list of active storage areas. The first ratio may be set according to the actual situation and is not limited herein, for example, a first ratio may be 95% or 100%.

By removing a storage area in the list of active storage areas whose remaining available space is lower than the lower limit value, an availability rate of the storage areas in the list of active storage areas may be increased, and the count of storage areas in the list of active storage areas may be reduced, thereby making the storage node to apply for the new storage area to realize the storage of the data to be written when no storage area that may satisfy the requirement of the amount of data to be written in the list of active storage areas.

In some embodiments, after removing the storage areas from the list of active storage areas that has a used space greater than or equal to a preset percentage of the list of active storage areas, removed storage areas may be set as a non-writable storage area. In some embodiments, the storage node may mark all the space of the removed storage area as used space, and/or report to the management node that the removed storage area is fully written, so that the storage node and the management node are clearly and accurately aware of the amount of space available in the storage device.

It may be understood that since the information reported by the storage node to the management node does not contain information of the type of the individual storage devices added on the storage node and the various storage areas in the storage devices. The storage node may report to the management node only that a storage space corresponding to the removed storage area is occupied after removing a storage area having a used space greater than or equal to a first percentage from the list of active storage areas. In some embodiments, the storage node may set all of the space of the removed storage area to be used when reporting to facilitate an accurate management of the space of the storage device. Given this, the storage node may make the management node aware of the amount of used space and the amount of unused space in the storage node by “reporting the amount of used space in the storage node this time to the management node, and the amount of used space this time includes a total amount of unused space in all the storage areas removed from the list of active storage areas this time”, and the management node may be insensitive and fully transparent to the disk type.

In some embodiments, the storage node (e.g., a first storage node) may remove a storage area whose usage time is longer than the reuse cycle from the list of active storage areas of a storage device corresponding to the storage node.

The usage time may reflect a time interval between a last time that data was written to the corresponding storage area and a current moment. For example, a time of writing the data to a storage zone is July 15th of year X, and a current time is July 16th of year X, then a usage time corresponding to the storage zone would be 1 day, and so on.

In some embodiments, a usage time of each of the storage zone may be equal to a difference between the current time and an earliest write time of all data within the storage zone.

The reuse cycle may reflect a limitation of a maximum usage duration of the storage area. In some embodiments, the reuse cycle may be set according to the actual situation, for example, a reuse cycle may be 1 day, 2 days, and so on. In some embodiments, a reuse cycle may be a fixed value. In some embodiments, the reuse cycle may be dynamically adjusted according to a real-time situation of the storage node. In some embodiments, reuse cycle values corresponding to different storage areas may be the same or different.

In some embodiments, the storage node may remove the used storage area from the list of active storage areas of the storage device corresponding to the storage nude when the usage time of a used storage area has been longer than the reuse cycle. The used storage area refers to a storage area that already has stored content.

Understandably, a setting of the reuse cycle may make a storage time span of the files in each of the storage areas not exceed the reuse cycle, and an expiration time of all the files in the storage area is approximately the same, thereby avoiding the storage time span of the files in the storage area being too large, facilitating subsequently cleaning the data in the expired storage area, improving a recycling rate of the storage space, and thereby improving a space utilization rate of the storage devices and the system.

In some embodiments, the storage node may delete the data in the expired storage area in the storage device to change the expired storage zone into the new storage zone. For example, when all data (e.g., blocks) stored in a storage Zone of the SMR disk are expired, the storage node may recover space in the storage Zone, and the data in the storage Zone will be entirely deleted, changing this storage Zone into a new storage Zone.

The expired storage area refers to a storage area where a write duration of stored data exceeds an expiration date. The write duration may be a difference between a moment when a moment was written to the storage area and a current moment.

In some embodiments, an expiration length of the data may be contained in the data write request or the data storage request. In some embodiments, the expiration length of the data may be determined by the storage node or the management node based on related information of the data that the client requests to write. For example, the storage node may determine the expiration length corresponding to the written data based on the type of the written data, frequency of use of the written data, and the like. In some embodiments, the expiration length of the data may be set based on an actual situation such as the requirement of the client, for example, a expiration length of the data may be 30 days or 15 days, and is not limited herein.

The expired storage area is changed into a new storage area by deleting the data in the expired storage area in the storage device, the expired data may be cleaned in time and the disk utilization rate may be improved.

In 460, the first storage node writes the data sent by the client to the target storage area. In some embodiments, step 460 may be performed by the processor 110 or the distributed storage system 200 (e.g., the storage node 230).

In some embodiments, each of the first storage nodes may write the data sent by the client to a selected target storage area. For example, In response to determining that the writing object contains the block 1, the block 2, and the block 3, and the management node determines three first storage nodes according to an writing object, the storage node 1 writes the block 1 to the target storage area corresponding to the storage node 1, the storage node 2 writes block 2 to the target storage area corresponding to the storage node 2, and the storage node 3 writes the block 1 to the target storage area corresponding to the storage node 3.

In some embodiments, after the storage node writes the data sent by the client to the target storage area, the written data and the target storage area may be stored, and a mapping relationship between the target storage area and the storage device to which the target storage area belongs (as shown in FIG. 5).

Through the mapping relationship between the storage Zone ID and the storage device to which the Zone ID belongs and the mapping relationship between the Zone ID and the written data, the mapping relationship between the stored data and the storage area may be expressed, and the storage node may obtain in which storage area of which storage device each data is stored based on the above mapping relationship, so that it is convenient for the storage node to find the corresponding data based on the data information from the storage device of the storage node.

In some embodiments, the storage node may store the mapping relationship between the written data and the target storage area and the storage device to which the target storage area belongs in a conventional magnetic recording partition (i.e., a CMR partition) of the SMR disk. In some embodiments, a k-v database may be provided in the CMR partition of the SMR disk configured to store the mapping relationship between the written data and the target storage area and the storage device to which the target storage area belongs. For example, as shown in FIG. 5, the SMR disk of the storage node contains an SMR partition and the CMR partition, and when the SMR disk is used for data write, the data may be written to the target storage area of the SMR partition, and the mapping relationship between the written data and this target storage area may be stored in the CMR partition. More specifically, the mapping relationship between the written data and this target storage area may be stored in a k-v database in the CMR partition, thereby improving an in convenience of reading the mapping relationship. Given this, the storage node may load the mapping relationship between the written data and the storage area directly from the CMR partition of the SMR disk.

In some embodiments, the storage node may store both the written data and the mapping relationship of the target storage area into the memory of the storage area. By storing the mapping relationship in a memory, a storage location of the data may be determined directly based on the data in the memory when performing operations such as data query and recovery, thereby improving the efficiency of the storage node in managing the SMR disk.

In some embodiments, the storage node may update both the CMR partition and the mapping relationship stored in the memory. In some embodiments, the storage node may periodically scan, compare, and update the CMR partition and the mapping relationship stored in the memory. In some embodiments, the mapping relationships may be loaded into the memory from the CMR partition when the storage node is started. The above operations of updating, loading, and the like may allow the memory to load an accurate mapping relationships between the written data and the storage area.

In some embodiments, after the first storage node writes the data sent by the client, information (e.g., information such as data offset in the file, data length, and/or state bits) and/or storage space information related the written data (e.g., data blocks) may be reported to the management node.

Information reporting of the storage node may not only help the management node know in which storage node each data is stored, thereby facilitating the management node to perform the operation such as data query and recovery based on the distribution of the data in the storage node, but also helps the management node know the available storage space and the situation of the used storage space of each of the storage nodes, thereby facilitating the management node to confirm a list of the first storage node corresponding to the data storage request, and a list of third storage nodes corresponding to the data read request, based on a data storage situation of each of the storage nodes.

In some embodiments, the information reported by the storage node to the management node may not include storage space information of each disk type and each storage area of the storage device added on the storage node. In this case, the storage node confirms to which disk and to which area of the disk the data to be written is to be written, so that the management node only needs to determine the storage node configured to store the client data based on the storage space information of an entire storage node reported by the storage node (i.e., used storage space information and/or unused storage space information in the storage node), thereby realizing a full transparency and non-awareness of the disk type of the storage node to the management node.

In some embodiments, a storage node may remove the target storage area from a list of active storage areas of a storage device corresponding to the storage node in response to determining that the used space of the target storage area is greater than or equal to the first ratio.

The used space may refer to a space that has been used by the storage area. For example, the used space may be equal to the size of the data that has been written in the storage area.

The first ratio may refer to an upper limit value of a ratio between the used space of the storage area and all the storage space. In some embodiments, the first ratio may be determined based on the type of storage device. In some embodiments, the first ratio may be determined by using a machine learning model. In some embodiments, the first ratio may be determined through mathematical statistics. In some embodiments, the first ratio may be set according to actual needs. For example, a first ratio may be 95%, 100%, etc.

In some embodiments, the storage node may calculate the used space of the target storage area after each time the target storage area complete the data write, and when a ratio of the used space of the target storage area to the entire storage space of the target storage area is greater than or equal to the first ratio, the storage node may remove the target storage area from the list of active storage areas of the storage device corresponding to the storage node.

Understandably, by removing a target storage area with used space greater than a first ratio from the list of active storage areas, the count of storage areas with large used space in the list of active storage areas may be reduced, which facilitates applying for a new storage space configured to store the data to be written when the list of active storage areas does not have a requirement of the amount of data to be written, stores the data to be written, thereby increasing the availability rate of the storage areas in the list of active storage areas.

In some embodiments, after removing the target storage area from the list of active storage areas, the storage node may mark all space in the target storage area as used, and/or report to the management node that the target storage area is fully written, so that the storage node and the management node are clearly and accurately aware of the amount of space available in the storage device.

Through the operation of the embodiments of the present disclosure, the management node may achieve the full transparency and the non-awareness of the disk types on the storage node to the management node, improve the efficiency of distributed storage, and be compatible with other types of disks such as the SMR disk and the CMR disk.

It should be noted that the above description of the process 400 is merely provided for the purpose of illustrating and is not intended to limit the scope of the present disclosure. For those skilled in the art, various amendments and variations of the process may be made under the teachings of the present disclosure. For example, in 420, the management node may determine at least one second storage node or at least one fourth storage node from the at least one storage node in response to the data storage request. As another example, the management node may determine at least a third storage node from the at least one storage node in response to the data read request. However, these variations and amendments do not depart from the scope of the present disclosure.

FIG. 5 is a schematic diagram illustrating information stored by a storage node according to some embodiments of the present disclosure.

In some embodiments, a public management module and a single disk management module may be included in the storage node (e.g., the storage node 230). The public management module is configured to manage an entire storage node, and a single disk management module is configured to manage the disk corresponding to the storage node. For example, as shown in FIG. 5, the storage node may include a public management module 510, a single disk management module 520 and a single disk management module 530. The single disk management module 520 is configured to manage SMR disks, and the single disk management module 520 is configured to manage CMR disks.

In some embodiments, as shown in FIG. 5, the public management module 510 may be configured to perform a block management (e.g., the block size, etc.), a block recovery management (e.g., recovery when the block is damaged or missed), block reporting management (e.g., reporting block information to the management node), disk sweeping management (e.g., periodic scanning of data states of all disk storage Zones), and node type management (e.g., determining the disk storage node that is stored based on sequence or determine other type of disk node). For example, the public management module 510 may determine a target storage disk in response to a data write request sent by the client or the management node. As another example, the public management module 510 may periodically scan the data states of the storage areas of all disks, and periodically update internal mapping relationships of the storage nodes.

In some embodiments, the single disk management module (e.g., the single disk management module 520 or the single disk management module 530) may be configured to manage one or more types of information, such as on-line or off-line corresponding to the disk, block (e.g., the block size) corresponding to the disk, partition (e.g., free space, used space, and the like, in the storage area corresponding to the disk) corresponding to the disk, or metadata (e.g., metadata storage duration, etc.) corresponding to the disk.

In some embodiments, when the disk is an SMR disk, the single disk management module 520 may manage the information such as the mapping relationship between the storage area and the disk, the mapping relationship between the storage area and the block, the list of active storage areas, and the reuse cycle of the storage area. For example, the SMR disk is divided into a CMR area and an SMR partition, and when the SMR partition is used for data writing, the single disk management module 520 may store the mapping of the storage area to the disk, the mapping of the storage area ID to the block to which the data is written, in an k-v database of the CMR partition of the SMR disk. As another example, the single disk management module 520 may remove a used storage area from the list of active storage areas when the usage time of the used storage area in the SMR disk has been more than the reuse cycle.

It should be noted that the above description of the FIG. 5 is merely provided for the purposes of illustrating and is not intended to limit the scope of the present disclosure. For those skilled in the art, various amendments and variations of the process may be made under the teachings of the present disclosure. However, these variations and amendments do not depart from the scope of the present disclosure.

FIG. 6 is a flowchart illustrating an exemplary distributed storage method executed by a storage node according to some embodiments of the present disclosure. In some embodiments, the process 600 may be executed by the processor 110 or the distributed storage system 200 (e.g., storage node 230). The schematic diagram of the operation of process 600 described below is illustrative. In some embodiments, one or more additional operations not described above and/or one or more operations not discussed may be configured to complete the process. Further, the order of the operations of the process 600 illustrated in FIG. 6 and described below is not intended to be limited.

In 610, a storage device configured to write data may be determined in response to the data write request. In some embodiments, 610 may be performed by the processor 110 or the storage node 230.

In conjunction with the above, when a storage node is determined as a storage node (e.g., the first storage node) configured to write the data, a storage device (target storage device) configured to write the data may be determined in response to the data write request sent by a management node (e.g., the management node 220) or a client (e.g., the client 210).

In some embodiments, when only one type of disk is added to the storage node, the disk may be determined to be a storage device used for writing data. When two or more types of disks are added to the storage node, the storage device configured to write the data may be determined from the two or more types of disks based on the preset storage policy. More detailed descriptions may be found in FIG. 4 and will not be repeated herein.

In step 620, in response to determining that the storage device is a shingled magnetic recording disk, at least one available storage area in a shingled magnetic recording disk is selected as a target storage area. In some embodiments, 620 may be executed by the processor 110 or the storage node 230.

In some embodiments, the storage node may select and determine one of the available storage areas in the shingled magnetic recording disk as the target storage area. In some embodiments, the storage node may select at least two available storage areas in the shingled magnetic recording disk, and determine at least two selected available storage areas as the target storage area. When one of the available storage areas in the shingled magnetic recording disk is selected as the target storage area, the target storage area may be a storage area with a remaining space in the SMR disk that is greater than or equal to the amount of data to be written (i.e., the amount of data to be sent by the client).

In conjunction with the above, the storage node determined as being configured to store the written data may select one or more storage areas capable of storing the data sent by the client from the list of active storage areas of the target storage device, and the selected storage areas are determined as the target storage area. Accordingly, in response to determining that a type of storage device determined by the storage node configured to store the written data is an SMR disk, the storage node may select one or more storage areas capable of storing the data sent by the client from the list of active storage areas of the SMR disk, and determine the selected storage area as the target storage area. The list of active storage areas is composed of the storage areas capable of responding to the data write operation.

In some embodiments, the storage node may determine whether the at least one storage area capable of storing the data exists in the list of active storage areas (e.g., the shingled magnetic recording disk). In response to determining that the at least one storage area capable of storing the target data exists in the list of active storage areas of the shingled magnetic recording disk, the at least one storage area is selected from the storage device as the target storage area. In response to determining that no storage area capable of storing the target data exists in the list of active storage areas of the shingled magnetic recording disk, a new storage area of the storage device (for example, the shingled magnetic recording disk) is added to the list of active storage areas, and the new storage area is determined as the target storage area (as shown in FIG. 10).

In some embodiments, an addition of the new storage area of the storage device (e.g., the shingled magnetic recording disk) to the list of active storage areas may include: in response to determining that no storage area capable of storing the target data exist in the list of active storage areas of the shingled magnetic recording disk, determining whether a size of the list of active storage areas is less than the upper limit. In response to determining that the size of the list of active storage areas is less than the upper limit, the new storage area of the storage device is added to the list of active storage areas.

More descriptions may be found in the description in FIG. 4 or FIG. 10 and will not be repeated herein.

In 630, the data sent by the client is sent to the target storage area. In some embodiments, 630 may be performed by the processor 110 or the storage node 230.

A storage node determined as a storage node configured to store the written data may write the data from the client (e.g., client 210) into the one or more target storage areas in response to the data write request and determining the one or more target storage areas.

In some embodiments, in response to determining that the storage device determined by the storage node configured to store the written data is other types of disks (e.g., the CMR disk, or a LMR disk, etc.), the data coming sent by the client may be written to the other types of disks through a standard file system, and the files in the other type of disk may be managed through the standard file system.

In some embodiments, the storage node may obtain and store information (e.g., a disk type) of the added storage device, so that the storage device loaded on the storage node is facilitated to manage. For example, the user may mark a disk type when adding a disk corresponding to a storage node in a distributed file system network management interface, and the storage node obtains and stores the disk type, such that various types of disks (e.g., CMR disks and SMR disk, etc.) by the storage node are facilitated to manage through node types, respectively. Given this, the storage node responds to the writing of data (e.g., a data block of the object) through the management system of different disk types, and the management node does not need to sense the type of disk to which the data is written, so that the management node of the distributed storage system may realize a transparent enrollment to the node of the disk (e.g., SMR, CMR, or LMR).

In conjunction with the above, after writing the data sent by the client to the target storage area, the storage node may store the mapping relationship between the written data and the target storage area and the storage device to which the target storage area belongs. For example, the storage node may store the mapping relationship in the CMR partition of the SMR disk (as shown in FIG. 5); or store the mapping relationship in the CMR partition of the SMR disk and in memory.

The storage node may determine the location of the storage area where the corresponding data is stored based on the mapping relationship between the written data and the storage area, and then retrieve the corresponding data from a corresponding location, which may achieve a fast response to a search request for the data. Specifically, a system overhead required for an internal Zone state management within the one or more storage node is minimal. By utilizing caches for various mapping relationships, the one or more storage nodes may rapidly locate a position of each block. This process bypasses standard file system cache and directly operates a write pointer of Zone, and a performance of file write will not be decreased by various levels of caches. Therefore, a cost-effective advantage of the SMR disk is significantly improved based on guarantee of performance. After practical tests, when a storage node is 36 disks (14 TB: 70,000 Zones), the count of internal Zone caches in the distributed storage system is in the million level after long-term operation, i.e., the caches of the mapping relationship have very little impact on the file write performance.

In some embodiments, after the storage node writes the data sent by the client to the target storage area, the storage node may report the related information of the data block of the storage node and/or the storage space information to the management node.

In some embodiments, when the data block is stored as unit, the storage node may periodically scan the states of all blocks of data of the storage device corresponding to the storage node. In some embodiments, the storage node may report the states of all data blocks of the storage node to the management node, such that the management node confirms the state of the object and the files corresponding to each data block based on the state of each of the data blocks and the state of the data blocks stored on the remaining storage nodes associated with each data block. For example, when the count of damaged data blocks of an object is less than or equal to a preset value, the storage node may mark the state of the object corresponding to the damaged data blocks and the files corresponding to the damaged data bock as to be restored. When the count of damaged data blocks is greater than the preset value, the state of the object corresponding to the damaged data blocks and the files corresponding to the damaged data blocks is marked as damaged.

By storing the storage node's mapping relationship between the written data and the target storage area and the storage device to which the target storage area belongs; and/or, reporting the related information of the data blocks in the storage node and/or the storage space information of the storage node to the management node, the management node are facilitated to grasp a data storage situation of the storage node in real time, and it may achieve a quick response to the writing and searching request of the data through the mapping data.

More descriptions regarding the storage of the storage node mapping relationship and information uploading may be found in FIG. 4.

In some embodiments, the storage node may remove a storage area whose usage time exceeds than a reuse cycle from the list of active storage areas (as shown in FIG. 10); and/or remove the target storage area from the list of active storage areas in response to determining that a used space in the target storage area is greater than or equal to the first ratio. In some embodiments, the storage node may delete all data in the expired storage area in the shingled magnetic recording disk to change the expired storage area into the new storage area. Specific descriptions may be found in FIG. 4 and its related descriptions.

In responses to that the storage device is a shingled magnetic recording disk, the storage node configured to store the written data may select at least one of the available storage areas of the shingled magnetic recording disk as the target storage area, and write the data sent by the client to the selected target storage area. Therefore, the management node only needs to determine the storage node for storing the data that the client has requested to be written, and the determined In this way, the management node only needs to determine the storage node that stores the data requested to be written by the client based on the data storage request of the client, and one or more determined storage nodes determines on whether to allocate the data sent by the client to its SMR disk and to which storage area of the SMR disk, such that the management node does not need to manage and maintain all the storage areas of all the SMR disk, which greatly reduces the management burden of the management node, and improves the efficiency of the distributed storage of the management node.

It should be noted that the above description of the process 600 is merely provided for the purposes of illustrating and is not intended to limit the scope of the present disclosure. For those skilled in the art, various amendments and variations of the process may be made under the teachings of the present disclosure. However, these variations and amendments do not depart from the scope of the present disclosure.

FIG. 7 is a flowchart illustrating an exemplary distributed storage method executed by a client according to some embodiments of the present disclosure. In some embodiments, the process 700 may be executed by the processor 110 or the distributed storage system 200 (e.g., client 210). The schematic diagram of an operation of process 700 presented below is illustrative. In some embodiments, one or more additional operations not described above and/or one or more operations not discussed may be utilized to complete the process. Further, the order of the operations of the process 700 illustrated in FIG. 7 and described below is not intended to be limited.

In 710, a data storage request is sent to the management node to cause the management node to determine at least one first storage node from at least one storage node based on a data storage request. In some embodiments, 710 may be executed by the processor 110 or the client 210.

In conjunction with the above, when a data storage requirement exists on the client, the data storage request may be sent to the management node to cause the management node to determine the at least one storage node configured to store the data to be written from the plurality of storage nodes of the distributed storage system (e.g., distributed storage system 200) based on the data storage request.

In some embodiments, the data write request may include information such as the size, the type (e.g., video, document, audio, image, etc.), the name (e.g., file/object identifier, or keyword), and an importance degree (e.g., frequency of use) of the data to be written.

In some embodiments, the data requested by the client to be written to the storage node (i.e., the data to be written) may include the data blocks of objects (also referred to as extracts of objects). An object may include data of a file and a set of attribute information (Meta Data), and each object may include the plurality of files or may be a portion of a particular file. In some embodiments, the data storage request may include a plurality of data blocks (i.e., the count of blocks) for the object. In some embodiments, a size of data block (i.e., a size of a block) of the object may be included in the data storage request. In some embodiments, the count of data blocks and the sizes of the data blocks of the object may be included in the data storage request.

In some embodiments, the data storage request may include types of storage device for data storage, such as a sequential storage-based disk (e.g., the SMR disk) or a traditional disk (e.g., the CMR disk or the LMR disk).

In some embodiments, the data storage request may include a count of extracts and/or an extract size of a partial object of the data to be written. For example, if the total data requested to be written includes a plurality of video files, and the plurality of video files are written in batches, each sent data storage request corresponds to one or more of the plurality of video files, and accordingly, each data storage request includes the count of extracts and/or the extract size of the one or more video files.

In 720, the data write request is sent to the at least one first storage node to cause the at least one first storage node to determine at least one target storage area from the available storage areas of the respective storage devices. In some embodiments, 720 may be executed by processor the 110 or the client 210.

The client 210 may send the data write request to each of the at least one first storage node to cause the at least one first storage node to determine the target storage device for data storage and cause the target storage area from the target storage device configured to write the data sent by the client. For example, after sending the data write request, at least one available storage area in the shingled magnetic recording disk may be selected as the target storage area when the storage device for data storage of the first storage node is a shingled magnetic recording disk.

In some embodiments, the data write request may include a size of the data to be written, so that each storage node of the at least one first storage node belonging to the at least one first storage node determines whether to allocate the data sent by the client to its own storage device (e.g., an SMR disk) based on the size of the data to be written in the corresponding data write request, and determines to which storage area of its own storage device the data coming sent by the client is allocated.

In some embodiments, when the data requested by the client to be written to the storage node is a data block of the object, the size of the object and/or the size of the data block may satisfy the preset condition. For example, when the data requested by the client to be written to the storage node is a data block of the object and the write file includes a plurality of objects, a size of the object may be a preset fixed value, and the block size of the object may be a preset fixed value (e.g., 256 MB).

In some embodiments, the client may determine a size of the first object to which the write file belongs based on the remaining space of the storage area of the storage device (e.g., the SMR disk) on the storage node, i.e., the first object to which the write file belongs is of variable size. Specifically, after initiating the data write request, the client may determine the size of the first object of the write file based on the capacity of the target storage area selected by each first storage node, and extract the first object from the write file based on the size. The capacity of the target storage area may reflect the size of the available space of the storage area, for example, a capacity of the target storage area is 256M, 200M, 153M, 128M, 58M, and the like.

In some embodiments, the client may determine a capacity sum of the target storage areas of the at least one first storage node as a size of the first object. In some embodiments, the client may determine the capacity sum of the target storage areas of the at least one first storage node as a size of the first object after subtracting a preset value. For example, the client may determine the capacity size after subtracting 1M, 3M, or 5M, etc. from the capacity sum as the size of the first object.

In some embodiments, the client may divide the first object into at least one data block, and respectively send the at least one data block to the at least one first storage node to cause the at least one first storage node to write the corresponding data block to the determined target storage area, respectively. Exemplarily, if the management node 220 determines a target count of first storage nodes for storing the data sent by the client, the client 210 may divide the first object into a target count of data blocks and respectively send the target count of data blocks to the target count of first storage nodes to cause the target count of first storage nodes to respectively write and store the data blocks corresponding to the target count of first storage nodes.

In some embodiments, the size of each data block of the first object may be less than or equal to the capacity of the target storage area of the first storage node corresponding to each data block. For example, a data block 1 is equal to a value of the available space of the target storage area of a first storage node 1, a data block 2 is equal to the value of the available space of the target storage area of a first storage node 2, . . . , and a data block N is less than a value of the available space of the target storage area of a first storage node N. As another example, a data block 1 is less than a value of the available space of the target storage area of a first storage node 1, a data block 2 is equal to a value of the available space of the target storage area of a first storage node 2, . . . , and a data block N is less than a value of the available space of the target storage area of a first storage node N.

The client extracts and divides the first object from the write file based on the capacity of the target storage area selected by each first storage node, the size of the first object is allowed to be written to be variable, and the first object is divided into the target count of data blocks corresponding to the count of first storage nodes, the space within the storage area of the storage devices (e.g., SMR disk) on the individual storage nodes may be fully utilized.

In some embodiments, when the amount of data written to the first object corresponding to the target count of first storage nodes is all greater than or equal to the second ratio, the client may extract the second object from the write file, i.e., extract a next object of the first object from the write file.

The amount of data written to the first object corresponding to the first storage node may reflect a ratio of the data size of the first object that has been written to a target count of first storage nodes to a total data size of the first object. In some embodiments, the client may obtain the amount of data written to the first object in real time through a data write process of the first storage node.

In some embodiments, the second percentage may be preset based on experience or demand. For example, a second ratio may be 95% or 80%, etc. In some embodiments, the second ratio may be determined in real time by a preset algorithm (e.g., a trained machine learning model).

In some embodiments, the size of the second object may be equal to, less than, or greater than the size of the first object. In some embodiments, the size of the second object may be determined based on the data storage situation of the storage node. In some embodiments, the size of the second object may be randomly determined by the client. In some embodiments, the size of the second object may be determined based on the preset condition, which is not limited by the present disclosure.

In some embodiments, a duplicate content of a preset size exists between a content contained in the second object and the content contained in the first object. In some embodiments, the content contained by the second object and the content contained by the first object may not completely overlap. In some embodiments, the location of the second object of the write file and the location of the first object of the write file may be adjacent or non-adjacent.

In some embodiments, the client may send the data storage request to the management node based on the second object to store the second object into one of the target count of second storage nodes corresponding to the second object.

The second storage node refers a storage node configured to store the second object. The client may determine the second object as a current object to be written and send a new data storage request to the management node, such that the management node determines the storage node (i.e., the second storage node) configured to store the second object from the at least one storage node. A determination of the second storage node is similar to a determination of the first storage node, and more descriptions may be found in FIG. 4 and/or FIG. 8, and will not be repeated herein.

When determining the at least one second storage node for storing the second object, the client or the management node may send the data write request to the at least one second storage node to cause the second storage node to determine the storage device configured to store the second object and a target storage area corresponding to the storage device based on the data write request. A determination of the storage device and/or the target storage area may be found in FIG. 4 and/or FIG. 6 and will not be repeated herein.

In some embodiments, the client may divide the second object into at least one (e.g., a target count of) data blocks and respectively send the at least one data block to the at least one second storage node to cause the second storage node to write the corresponding data block to the target storage area. In some embodiments, the at least one second storage node may store the target count of data blocks into which the second object is divided, and the target count of data blocks may be respectively stored to the target count of second storage nodes corresponding to the second object one by one.

When the second object is not a last object of the write file, in response to determining that the amount of write data of the second object of each of the target count of second storage nodes is greater than or equal to the second ratio, the client may extract the next object of the second object (which also becomes the third object) from the write file, and send the data storage request to the management node based on the third object to store the third object divided into a target count of data blocks, and store the target count of data blocks to ta target count of subsequent storage nodes corresponding to the third object (e.g., a fourth storage node) one by one, respectively. The client may repeat the process until a currently extracted object is the last object of the write file.

In some embodiments, the size of each object (e.g., the first object, the second object, the third object, . . . ) of the write file may unequal to each other, or the size of each object of the write fil may be the same, or sizes of at least two objects may be equal. In some embodiments, the count of storage nodes (e.g., the first storage node, the second storage node, the fourth storage node) corresponding to each of the objects may be unequal to each other, or all the same (e.g., all the same count of targets), or at least two of the count of storage nodes corresponding to each object are the same.

In some embodiments, during the process of performing data write, if the used space of the Zone having the smallest remaining space in the plurality of storage zones corresponding to the current object (e.g., the first object, the second object, or the third object) is greater than the second ratio, the storage node may notify the client, so that the client may perform a space pre-application operation for the next object (e.g., the second object, the third object, etc.), thereby realizing continuous writing of files.

It should be noted that the foregoing description of process 700 is merely provided for the purpose of illustration and is not intended to limit the scope of the present disclosure. For those skilled in the art, various amendments and variations of the process may be made under the teachings of the present disclosure. However, these variations and amendments do not depart from the scope of the present disclosure.

FIG. 8 is a flowchart illustrating an exemplary distributed storage method executed by a management node according to some embodiments of the present disclosure. In some embodiments, the process 800 may be executed by the processor 110 or the distributed storage system 200 (e.g., the management node 220). The schematic diagram of an operation of process 800 illustrated below is illustrative. In some embodiments, one or more additional operations not described above and/or one or more operations not discussed may be utilized to complete the process. Further, the order of the operations of the process 800 illustrated in FIG. 8 and described below is not intended to be limited.

In 810, at least one first storage node is determined from at least one storage node in response to a data storage request.

In some embodiments, the management node may determine the at least one storage node configured to store the data sent by the client based on the count of blocks and/or the block size of the object in the data storage request.

In some embodiments, the management node may obtain a count of blocks of the object based on the data storage request and determine the at least one first storage node from the at least one storage node based on the count of data blocks. The count of the at least one first storage node is equal to the count of data blocks. For example, the count of first storage nodes determined by the management node 220 may be equal to the count of blocks corresponding to the first object declared in the data storage request.

By determining the count of storage nodes used for data storage to be the same as the count of object blocks, the plurality of blocks of the object may be allocated to one storage node accordingly, so that different blocks of an object may not be stored to the same storage node, thereby avoiding file damage due to a single disk hardware failure, so that the reliability of the distributed storage system may be improved, that is, a minimum support for disk-level fault tolerance, which facilitates a management and a recovery of the object.

In some embodiments, the management node may select the at least one first storage node from various storage nodes to store the data requested to be written by the client based on the size of data block of the object and the remaining available space on each storage node.

In some embodiments, the management node may obtain the size of data block of the object based on the data storage request. The management node determines at least one first storage node from the at least one storage node based on the size of data block and the remaining available space of each storage node.

In conjunction with the above, a data storage request may include the size of data block of the object. A file may be divided into a plurality of objects of a fixed size, an object is divided into a plurality of data chunks, and one data block may be in a default size (e.g., 256M) or another size (e.g., the same size as the storage area). In some embodiments, the management node may extract the size of data block of the object from the data storage request.

The remaining available space of the storage node may reflect the sum of the available storage space of one or more storage areas of the storage node. For example, in response to determining that one or more storage areas that are not filled exists in the storage node, the remaining available space of the storage node is the sum of the remaining available storage space of the one or more storage areas.

In some embodiments, the management node may determine the remaining available space of each storage node based on the file storage information and/or storage space information reported by each storage node.

In some embodiments, the management node may determine a storage node having remaining available space greater than or equal to the size of data block of the object as the storage node (e.g., a first storage node, a second storage node, etc.) configured to store the data sent by the client.

By determining the storage nodes configured to store the data sent by the client based on the size of data block and/or the count of the objects, the storage space of the storage node may be fully used, and a storage failure or an efficiency degradation caused by insufficient remaining available space on the storage nodes is avoided.

In some embodiments, the management node may determine the size of entire file to which the current object belongs based on the size and/or the count of data blocks of the current object. In some embodiments, the management node may predict the size of the file to which the current object belongs by using the trained machine learning model. In some embodiments, the management node may determine the storage node from the distributed storage system configured to store next one or more objects corresponding to the file based on the size of the file to which the management node belongs. For example, the management node 220 may predict the size of the entire write file to which the first object belongs based on the count of blocks and the size of blocks of the first object, and/or determine corresponding at least one second storage node of the next object (e.g., the second object) of the first object in the entire write file.

In some embodiments, the management node may determine a size of a supplemental file associated with the object based on the block size and/or the count of data blocks of the object. For example, the management node 220 may predict a size of an additional file (e.g., subsequent data to be supplemented for writing) associated with the entire write file based on the count of blocks and the block size of the first object, the count of blocks and a block size of the second object, and the count of blocks and a block size of the third object. In some embodiments, the management node may determine a storage node configured to store the additional file from the plurality of storage nodes of the distributed storage system.

In 820, the at least one first storage node is sent to the client to cause the client to send a data write request to the at least one first storage node.

In some embodiments, the management node may feed a list of storage nodes including determined at least one (e.g., a target count of storage nodes) first storage node to the client, such that the client send the data write request to each storage node in the list of storage nodes, thereby realizing the data write.

In some embodiments, when all the data of the write file (e.g., all the objects) sent by the client are all written to the distributed storage system, i.e., when the file write is closed, the management node may update the count of objects of the write file according to an actual length of the write file. In some embodiments, a scenario where a pre-application object is not written exists, i.e., when no data writes after sending the data storage request, the management node may delete the metadata information of the object corresponding to the management node.

In some embodiments, for each of the at least one storage node, the management node may obtain states of all data blocks from the storage node, determine states of all data blocks of the object based on the mapping relationship between the object and the data blocks in the storage node, and determine the state of an object and a state of a file corresponding to the object based on the states of the all data blocks of the object. In some embodiments, the management node may determine a target storage node from the at least one storage node in response to determining that the state of the object is to be restored; and send storage node information and the states of all data blocks of the object to the target storage node to facilitate the target storage node to recover a damaged data blocks in the object. More descriptions may be found in the description in FIG. 9.

It should be noted that the above description of the process 800 is merely provided for the purposes of illustrating and is not intended to limit the scope of the present disclosure. For those skilled in the art, various amendments and variations of the process may be made under the teachings of the present disclosure. For example, in 810, the management node may determine a target count of second storage nodes (or a fourth storage node) equal to the count of blocks of the second object (or the third object) configured to store the second object (or the third object) from a plurality of storage nodes in the distributed storage system in response to a data storage request. However, these variations and amendments do not depart from the scope of the present disclosure.

Since the distributed storage system will inevitably occur failures of the disk and distributed nodes, resulting in damage and missing of objects and/or data blocks corresponding to some files. Given this, the states of the objects and the data blocks in the distributed storage system may be scanned and confirmed, and damaged and/or missing data blocks may be recovered to enhance a fault tolerance of the distributed storage system and to safeguard an integrity of the files.

FIG. 9 is a flowchart illustrating an exemplary data recovery according to some embodiments of the present disclosure. In some embodiments, the process 900 may be executed by the processor 110 or the distributed storage system 200 (e.g., the management node 220). The schematic diagram of an operation of the process 900 described below is illustrative.

In some embodiments, one or more additional operations not described above and/or one or more operations not discussed may be configured to complete the process. Further, the order of the operation of the process 900 illustrated in FIG. 9 and described below is not intended to be limited.

In 910, a state of an object and/or a file is determined.

In some embodiments, for each of the at least one storage node, the management node (e.g., the management node 220) may obtain the states of all data blocks in the storage node from the storage node, determine the states of all data blocks of the object based on the mapping relationship between the object and the data blocks in the storage node, and determine the state of the object and the state of the file corresponding to the object based on the states of all data blocks of the object.

In conjunction with the above, the storage node may periodically scan the states of all data blocks on the corresponding storage device, and report the data block state to the management node, so that the management node may determine the state of the object and/or the file to which the data block belongs based on the data block state.

In some embodiments, for each of all data blocks of the storage node, the management node may confirm the state of the object corresponding to the data block and/or the file to which the object belongs based on the state of the data block and the state of a data block stored in the remaining storage nodes that is the same as the object to which the data block belongs. The states of the data block may include abnormal (e.g., damaged and/or missing) and normal. In some embodiments, the management node may obtain the data blocks and/or the data block states stored on the remaining storage nodes that are the same as the object to which the data block belongs based on the mapping relationship between the data block and the object.

In some embodiments, the management node may determine whether the abnormal data blocks in the object to be recovered based on the count of abnormal data blocks of the object. In response to determining that the abnormal data blocks in the object can be recovered, the object and/or the file to which the object belongs is marked as to be recovered; otherwise, the object and/or the file to which the object belongs is marked as damaged. The data capable of recovering and the data not capable of recovering may be distinguished through file marking, thereby facilitating an implementation of data recovery.

In some embodiments, the management node may mark the state of the object and/or the file to which the object belongs as to be restored when the count of abnormal data blocks in the object is less than or equal to a preset count threshold; and mark the state of the object and/or the file to which the object belongs as damaged when a count of abnormal data blocks in the object is greater than the preset count threshold.

The preset count threshold may be determined according to the count of data blocks and/or a determination operation of data block. Exemplarily, when the data blocks of the object are obtained through a corrective coding technique, i.e., when the object is divided into N+M (a corrective code) data blocks (block), a preset count threshold may be equal to M.

Understandably, the files or the objects in the states of to be restored state need to trigger a restore action to improve the fault tolerance of the file and the system and to safeguard the integrity of file.

In 920, in response to determining that the state of the object is to be restored, a target storage node is determined from the at least one storage node.

In some embodiments, the management node (e.g., the management node 220) may determine the target storage node related to an object from all storage nodes of the distributed storage system when the state of the object is to be restored due to the loss or absence of the data blocks.

The target storage node refers to a storage node that stores related information of an object to be recovered. In some embodiments, the target storage node may be a new storage node, such as a storage node storing the objects to be recovered. In some embodiments, no data may be written in the target storage node, or the available space is greater than a preset value.

In 930, storage node information and states of all data blocks of the object are sent to the target storage node to facilitate the target storage node to recover damaged data blocks in the object.

In some embodiments, a management node (e.g., the management node 220) may send the storage node information and the states of all data blocks in the object to the target storage node to make the target storage node to read in undamaged data blocks of the object based on the storage node information, and recover the target data block of the object based on the undamaged data blocks. The storage node information of the data blocks may include information such as an identifier of a storage node storing the data blocks.

In some embodiments, the target storage node may determine the abnormal data blocks (e.g., damaged data blocks and/or a missing data blocks) of the object and a storage node storing the abnormal data blocks based on the storage node information and states of all data blocks in the object. In some embodiments, the target storage node may delete the damaged data blocks (and/or the missing data block) of the object and related storage device cache, and mark the state of a source damaged data block (and/or missing data block) as deleted. The storage device cache may include the mapping relationship between the data blocks and the storage area. The source damaged data block refers to an original data block in which the damaged data blocks and/or the missing data block is stored in the storage node. The target data block refers to a normal data block corresponding to the damaged data blocks and/or the missing data blocks. For example, the target storage node may control the storage node storing the damaged data blocks and/or the missing data block to delete the damaged data blocks and/or the missing data blocks, and control the mapping relationship between the damaged data blocks and/or the missing data block and the storage area.

In some embodiments, the target storage node may recover a target data block corresponding to the damaged data blocks based on the storage node information of all data blocks of the object and write the target data block to the target storage node. In some embodiments, the target storage node may determine the undamaged data blocks (i.e., the normal data blocks) of the object and a storage node that stores the undamaged data blocks. In some embodiments, the target storage node may read the undamaged data blocks from the storage node where the undamaged data blocks is stored and recover the target data block of the object based on the undamaged data blocks.

In some embodiments, the target storage node may recover the target data block of the object based on a type of storage device to which the undamaged data blocks corresponds. For example, the target storage node may determine in which type of disk the undamaged data blocks is stored based on a correspondence relationship between the undamaged data blocks and the disk. Further, if the undamaged data blocks are stored in an SMR disk, the storage area of the undamaged data blocks may be determined according to the correspondence between the undamaged data blocks and the storage area, and then the undamaged data blocks may be read from the storage area of the undamaged data blocks. If the undamaged data blocks are stored in other types of disks such as the CMR disk, the undamaged data blocks may be read from the other types of disks such as the CMR disk through the standard file system.

In some embodiments, the target storage node may recover a target data block corresponding to the damaged data blocks (and/or the missing data blocks) according to how the data block of the object are obtained. For example, when the data blocks of the object are obtained through corrective deletion technique, the target storage node may recover the target data blocks of the object based on the undamaged data blocks through a corrective deletion code or calculation.

In some embodiments, the target data blocks of a recovered object may be written to the target storage node, or other storage nodes of the distributed storage system.

In some embodiments, the management node may determine a corresponding count of storage nodes based on a count of anomalous data blocks (also referred to as data blocks to be restored) in the object, so that after the target data blocks of the object are recovered to obtain, the target data blocks are written one-to-one correspondingly to a determined corresponding count of storage nodes that. The count of data blocks to be recovered may be equal to the count of storage nodes. In some embodiments, the determined corresponding count of storage nodes may include the target storage node.

By performing data recovery based on the storage node information of all data blocks in the object, not only the data recovery at a data block level may be realized, but also a file recovery function based on SMR bare disk management may be realized when the management node does not perceive the types of storage device (for example, does not perceive the difference between different types of disks such as the CMR disk and the SMR disk), which simplify a system architecture design.

It should be noted that the above description of the process 900 is merely provided for the purpose of illustrating and is not intended to limit the scope of the present disclosure. For those skilled in the art, various amendments and variations of the process may be made under the teachings of the present disclosure. However, these variations and amendments do not depart from the scope of the present disclosure.

FIG. 10 is a flowchart illustrating a list of active storage areas according to some embodiments of the present disclosure. In conjunction with the above descriptions, a storage node determined to be configured to store the write data may select one or more storage areas capable of storing the data sent by the client from a list of active storage areas of a target storage disk, and determine a selected storage area as the target storage area.

For example, as shown in FIG. 10, after the storage node (e.g., the first storage node, the second storage node, etc.) receives the data write request from an SDK input/output interface of the client, in response to determining that the storage disk is a shingled magnetic recording disk, the storage node may first determine whether an available area exists in the list of the active storage areas of the SMR disk, i.e., whether a storage area that is capable of storing the data from the client exists. In response to determining that the available area exists in the list of the active storage areas of the SMR disk, the storage node selects at least one of the available storage areas from the list of active storage areas as the target storage area, and takes the target storage area out of the list of active storage areas for use in response to this data write. In response to determining that the available area does not exist in the list of the active storage areas of the SMR disk, the storage node may determine whether the count of lists of active storage area is less than an upper limit. In response to determining that the count of lists of active storage area is not less than the upper limit, the storage node is temporarily unable to apply for a new storage area to write the data sent the client to the storage node, i.e., the space application failed, and at this time the storage node may internally mark that this storage disk is currently unavailable, and this write failed. In response to determining that the count of lists of active storage area is less than the upper limit, the storage node determines whether the new storage area exists, and in response to determining that the new storage area exists, a new storage area is obtained and is determined as the target storage area used for responding to this data writing; otherwise, it is determined that this write is failed.

In some embodiments, after the data writing is completed, the storage node may determine whether the storage area used for data writing satisfies the reuse condition, and in response to determining that the storage area used for data writing satisfies the reuse condition, a storage area (e.g., an available storage area that is removed, or an obtained new storage area) is put back into the list of active storage areas; otherwise, the process is ended, i.e., the storage area that is removed from the list of active storage areas, or the obtained new storage area, will no longer be put back into the list of active storage areas. The reuse condition may include that the usage time of the storage area has not been more than the reuse cycle.

It should be noted that the above description of the FIG. 10 is merely provided for the purposes of illustrating and is not intended to limit the scope of the present disclosure. For those skilled in the art, various amendments and variations of the process may be made under the teachings of the present disclosure. However, these variations and amendments do not depart from the scope of the present disclosure.

The embodiments of the present disclosure further provide an electronic device including a processor, wherein the processor is configured to execute instructions to implement the distributed storage method of any one of the above embodiments of the present disclosure (e.g., the process 400, the process 600, the process 700, the process 800, or the process 900).

The embodiments of the present disclosure further provide a non-transitory computer-readable storage medium that stores computer instructions. When the reading the instructions in the storage medium, the computer executes the distributed storage method of any one of the above embodiments of the present disclosure (e.g., the process 400, the process 600, the process 700, the process 800, or the process 900).

The basic concepts have been described above, apparently, for those skilled in the art, the above-detailed disclosure is only an example, and does not constitute a limitation of the specification. Although it is not clearly stated here, technical personnel in the art may modify, improve, and amend the present disclosure. The amendments, improvements, and amendments are recommended in the present disclosure, so the amendments, improvements, and amendments still belong to the spirit and scope of the demonstration embodiments of the present disclosure.

At the same time, the present disclosure uses a specific word to describe the embodiments of the present disclosure. For example, “one embodiment”, “an embodiment”, and/or “some embodiments” means a feature, structure, or feature of at least one embodiment related to the present disclosure. Therefore, it should be emphasized and noted that in the present disclosure, “one embodiment” or “an embodiment” or “an alternative embodiment” that are mentioned in different locations in the present disclosure do not necessarily mean the same embodiment. In addition, some features, structures, or features of one or more embodiments in the present disclosure may be properly combined.

In addition, unless the claims are clearly stated, the order of the processing elements and sequences, the use of digital letters, or the use of other names described in this description are not configured to limit the order and method of the present disclosure process and method. Although in the above disclosure, some examples are discussed through various examples that are currently considered useful, it should be understood that these types of details are only explained. The additional claims are not limited to the implementation examples of the disclosure. The requirements are required to cover all the amendments and equivalent combinations that meet the essence and scope of the implementation of the present disclosure.

For example, although the implementation of various components described above may be embodied in a hardware device, it may also be implemented as a software-only solution, e.g., an installation on an existing server or mobile device.

In the same way, it should be noted that, to simplify the statement of the disclosure and help the understanding of one or more embodiments, in the descriptions of the embodiments of the present disclosure, sometimes multiple features will be attributed to one embodiment, figures, or its descriptions. However, this disclosure method does not mean that the feature required by the object of this description is more than the feature mentioned in the claims. Rather, claimed subject matter may lie in less than all features of a single foregoing disclosed embodiment.

In some embodiments, the numbers expressing quantities or properties configured to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the count of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other amendments that may be employed may be within the scope of the application. Therefore, by way of example, but not of limitation, alternative configurations of the embodiments of the application may be utilized in accordance with the teachings herein. Accordingly, embodiments of the present application are not limited to that precisely as shown and described.

1. A distributed storage system, comprising a client, a management node, and at least one storage node, wherein:
the management node is configured to determine at least one first storage node from the at least one storage node in response to a data storage request of storing target data sent by the client; and
each of the at least one storage node is configured to write the target data sent by the client to a target storage area of a storage device corresponding to the storage node in response to a data write request when the storage node is determined to be the first storage node.

2. The system of claim 1, wherein to determine the at least one first storage node from the at least one storage node, the management node is configured to:
for each of the at least one storage node, determine a data storage situation of the storage node based on file storage information and/or storage space information reported by the storage node, wherein the storage space information consists of node information of the storage node; and
determine the at least one first storage node from the at least one storage node based on the data storage situation.

3. The system of claim 1, wherein
the target data includes at least one data block of an object; and
to determine the at least one first storage node from the at least one storage node, the management node is configured to:
obtain a count of the at least one data block of the object based on the data storage request; and
determine the at least one first storage node from the at least one storage node based on the count of the at least one data block, wherein a count of the at least one first storage node is equal to the count of the at least one data block.

4. The system of claim 1, wherein
the target data includes at least one data block of an object; and
to determine the at least one first storage node from the at least one storage node, the management node is configured to:
obtain a size of the least one data block of the object based on the data storage request; and
determine the at least one first storage node from the at least one storage node based on the size of the least one data block of the object and an available size of each of the at least one storage node.

5. The system of claim 1, wherein
the storage node includes a node related to a device based on sequential storage and a node related to a device of other type of storage; and
to write the target data to the target storage area of the storage device corresponding to the storage node, the storage node is configured to:
select at least one available storage area of the storage device as the target storage area; and
write the target data to the target storage area.

6. The system of claim 5, wherein to select the at least one available storage area of the storage device as the target storage area, the storage node is configured to:
select, from a list of active storage areas of the storage device, one storage area that is capable of storing the target data; and
determine the selected storage area as the target storage area;
wherein the list of active storage areas is formed by storage areas that are capable of responding to a data write operation.

7. The system of claim 6, wherein to select, from the list of active storage areas of the storage device, one storage area that is capable of storing the target data, the storage node is configured to:
determine whether at least one storage area capable of storing the target data exists in the list of active storage areas;
in response to determining that at least one storage area capable of storing the target data exists in the list of active storage areas, select the at least one storage area from the storage device as the target storage area; or
in response to determining that no storage area capable of storing the target data exists in the list of active storage areas,
add a new storage area of the storage device to the list of active storage areas; and
determine the new storage area as the target storage area.

8. The system according to claim 7, wherein to add the new storage area of the storage device to the list of active storage areas, the storage node is configured to:
in response to determining that no storage area capable of storing the target data exists in the list of active storage areas, determine whether a size of the list of active storage areas is less than an upper limit; and
in response to determining that the size of the list of active storage areas is less than the upper limit, add the new storage area of the storage device to the list of active storage areas.

9. The system of claim 1, wherein the storage node is further configured to:
remove one or more storage areas that have been used longer than a reuse cycle from the list of active storage areas of the storage device corresponding to the storage node; and/or
in response to determining that a ratio of a used space of the target storage area to a capacity of the target storage area is greater than or equal to a first ratio, remove the target storage area from the list of active storage areas.

10. The system of claim 1, wherein the storage node is further configured to:
change an expired storage area into a new storage area by deleting data of the expired storage area in the storage device.

11. The system of claim 1, wherein the storage node is further configured to:
store a mapping relationship between the target data and the target storage area, and a mapping relationship between the target storage area and the storage device to which the target storage area belongs; and/or
report, to the management node, related information of a data block in the storage node, and/or storage space information of the storage node.

12. The system of claim 11, wherein the management node is further configured to:
for each of the at least one storage node, obtain states of data blocks in the storage node from the storage node;
determine states of data blocks of an object based on a mapping relationship between the object and the data blocks in the storage node; and
determine a state of the object and a state of a file corresponding to the object based on the states of the data blocks of the object.

13. The system of claim 12, wherein the management node is further configured to:
in response to determining that the state of the object is to be restored, determine a target storage node from the at least one storage node; and
send storage node information and states of data blocks of the object to the target storage node to facilitate the target storage node to recover a damaged data block in the object.

14. The system of claim 13, wherein to recover the damaged data block in the object, the target storage node is configured to:
delete the damaged data block of the object and a storage device cache related to the damaged data block;
mark a state of a source damaged data block as deleted;
recover, based on the storage node information of the data blocks of the object, a target data block corresponding to the damaged data block; and
write the target data block to the target storage node.

15. The system of claim 1, wherein the client is configured to:
send the data write request to the at least one first storage node;
determine a size of a first object of a write file based on a capacity of the target storage area selected from each of the at least one first storage node; and
extract the first object from the write file based on the size of the first object; and
divide the first object into a target count of first data blocks; and
send the target count of first data blocks to the target count of first storage nodes, respectively, to cause each of the at least one the first storage node to write the corresponding first data block to the target storage area.

16. The system of claim 15, wherein to send the target count of first data blocks to the target count of first storage nodes respectively, the client is configured to:
when a ratio of an amount of data of the first object written to each of the target count of first storage nodes to a capacity of the first storage node is greater than or equal to a second ratio, extract a second object from the write file; and
send, based on the second object, the data storage request to the management node to store, into one of the target count of second storage nodes corresponding to the second object, each of the target count of second data blocks obtained by dividing the second object.

17. A distributed storage method implemented on a distributed storage system, wherein the distributed storage system includes a management node and at least one storage node, and the method is executed by the at least one storage node, the method comprising:
determining a storage device configured to write data in response to a data write request of storing target data sent by a client;
in response to determining that the storage device is a shingled magnetic recording disk, selecting at least one available storage area in the shingled magnetic recording disk as a target storage area; and
writing the target data sent by the client to the target storage area.

18. The method of claim 17, wherein selecting the at least one available storage area in the shingled magnetic recording disk as the target storage area includes:
selecting, from a list of active storage areas of the shingled magnetic recording disk, one storage area that is capable of storing the data sent by the client, and
determining a selected storage area as the target storage area; and
wherein the list of active storage areas is formed by storage areas that are capable of responding to a data write operation.

19-20. (canceled)

21. The method of claim 17, further comprising:
removing one or more storage areas that have been used longer than a reuse cycle from the list of active storage areas of a storage device corresponding to the storage device; and/or
in response to determining that a ratio of a used space of the target storage area to a capacity of the target storage area is greater than or equal to a first ratio, removing the target storage area from the list of active storage areas; and
changing an expired storage area into the new storage area by deleting all data in an expired storage area in the shingled magnetic recording disk.

22-25. (canceled)

26. A distributed storage method implemented on a distributed storage system, wherein the distributed storage system includes a management node and at least one storage node, and the method is executed by the management node, the method comprising:
determining at least one first storage node from the at least one storage node in response to a data storage request; and
sending the at least one first storage node and the states of the data blocks of the object to the target storage node, so that the client sending the data write request to the at least one first storage node.

27-29. (canceled)
